(19) United States
(12) Patent Application Publication
(10) Pub. No.: US 2025/0024132 A1
(43) Pub. Date: Jan. 16, 2025

(54) IMAGING CONTROL APPARATUS, IMAGING CONTROL METHOD, AND PROGRAM

(71) Applicant: FUJIFILM Corporation, Tokyo (JP)

(72) Inventor: Tetsu WADA, Kanagawa (JP)

(73) Assignee: FUJIFILM Corporation, Tokyo (JP)

(21) Appl. No.: 18/902,823

(22) Filed: Sep. 30, 2024

Related U.S. Application Data
(63) Continuation of application No. PCT/JP2023/012977, filed on Mar. 29, 2023.

(30) Foreign Application Priority Data
Apr. 7, 2022 (JP) 2022-064062

(51) Int. Cl. H04N 23/61; G06T 7/20; H04N 23/60

(52) U.S. Cl. CPC H04N 23/61; G06T 7/20; H04N 23/64; G06T 2207/30168

(57) ABSTRACT

An imaging control apparatus includes a processor. The processor is configured to cause an imaging apparatus to image a first imaging target region, and in a case where a part of a second imaging target region overlaps with a part of the first imaging target region while a moving object on which the imaging apparatus is mounted is moving, perform overlapping imaging processing of causing the imaging apparatus to image the second imaging target region. The processor is configured to, in a case where the overlapping imaging processing fails, perform interval imaging processing of causing the imaging apparatus to image a third imaging target region on a condition that a moving distance by which the moving object moves from a first position at which the first imaging target region is imaged by the imaging apparatus reaches a first predetermined moving distance.

This application is a continuation application of International Application No. PCT/JP2023/012977, filed Mar. 29, 2023, the disclosure of which is incorporated herein by reference in its entirety. Further, this application claims priority under 35 USC 119 from Japanese Patent Application No. 2022-064062 filed Apr. 7, 2022, the disclosure of which is incorporated by reference herein.

### BACKGROUND OF THE INVENTION

### 1. Field of the Invention

The disclosed technology relates to an imaging control apparatus, an imaging control method, and a program.

### 2. Description of the Related Art

JP2018-151775A discloses a method of creating a different physical quantity distribution diagram for each location within a target range. The disclosed method comprises a moving measurement step, a physical quantity setting step, an orthographic image creation step, and a distribution diagram creation step. The moving measurement step is a step of acquiring a plurality of ground images by imaging a ground with adjacent images overlapping with each other while moving in the target range, and measuring the physical quantity. The physical quantity setting step is a step of assigning a representative physical quantity to each ground image based on the physical quantity obtained in the moving measurement step. The orthographic image creation step is a step of creating an orthographic image of the target range based on the plurality of ground images. The distribution diagram creation step is a step of creating a physical quantity distribution diagram by displaying the representative physical quantity on the orthographic image.

JP2020-113843A discloses an image capturing support apparatus that supports capturing of a multi-view image used for restoring a three-dimensional shape model of a target object. The image capturing support apparatus comprises a feature point extraction unit that extracts a feature point, a matching processing unit, and a support information notification unit. The feature point extraction unit extracts the feature point in captured image data that is image data immediately previously obtained by imaging the target object, and in preview image data. The matching processing unit detects a first correspondence point of the feature point of each of the captured image data and the preview image data. The support information notification unit displays a preview image of the preview image data on which the first correspondence point is superimposed, and provides notification of support information corresponding to imaging on the preview image.

JP2010-045587A discloses a camera apparatus. The camera apparatus includes an image capturing unit, an image display unit, a shake detection unit, an image recording unit, a relative relationship operation unit, a display control unit, an overlapping operation unit, a notification unit, and an imaging control unit. The image capturing unit captures an image. The image display unit comprises at least a screen on which the image is displayed. The shake detection unit detects shaking of the apparatus during capturing of the image by the image capturing unit. The image recording unit records information about the image captured by the image capturing unit. The relative relationship operation unit obtains a relative relationship degree parameter representing at least a relative positional relationship between an imaging range of a first image immediately previously captured by the image capturing unit and recorded in the image recording unit and an imaging range of a second image captured subsequent to the first image by the image capturing unit. The display control unit generates an image for explicitly showing the relative positional relationship between the imaging ranges from the relative relationship degree parameter obtained by the relative relationship operation unit and displays the image on the screen of the image display unit together with the second image. The overlapping operation unit obtains an overlapping degree parameter indicating a degree of overlapping between the imaging range of the first image and the imaging range of the second image. The notification unit provides predetermined notification to an imaging person in accordance with the overlapping degree parameter obtained by the overlapping operation unit. The imaging control unit causes the image capturing unit to capture the image in a case where the overlapping degree parameter obtained by the overlapping operation unit falls within a predetermined threshold value range and where it can be determined from a detection output of the shake detection unit that the apparatus almost does not shake during image capturing by the image capturing unit.

Pamphlet of WO2018/168406A discloses an imaging control apparatus that controls imaging of a moving object comprising a camera. The imaging control apparatus comprises a wide angle image acquisition unit, an imaging information acquisition unit, an overlapping width information acquisition unit, a region information acquisition unit, an imaging region calculation unit, and a control unit. The wide angle image acquisition unit acquires a wide angle image in which an image of the entire imaging target is captured in a wide angle. The imaging information acquisition unit acquires imaging information related to the number of captured images or an imaging angle of view for a plurality of divided images acquired by performing macro imaging of a part of the image of the entire imaging target via the camera of the moving object. The overlapping width information acquisition unit acquires overlapping width information related an overlapping width in a case of generating a composite image of the imaging target by combining the plurality of divided images. The region information acquisition unit acquires imaging target region information related to a region of the image of the entire imaging target. The imaging region calculation unit calculates an imaging region of each divided image constituting the composite image in the wide angle image in which the overlapping width is secured, based on the imaging information, the overlapping width information, and the imaging target region information. The control unit causes the moving object to move, causes the camera to perform the macro imaging of each calculated imaging region, and acquires a captured macro image as a divided image. The control unit controls a position of the moving object at which the camera is caused to perform the macro imaging of each imaging region, by comparing an image corresponding to each imaging region of the acquired wide angle image with an image obtained by the macro imaging performed by the camera.

JP2014-519739A discloses an image registration method. The image registration method comprises a step of obtaining positional information from an apparatus, a step of obtaining first and second images from the apparatus, a step of identifying a plurality of correspondence regions by aligning a plurality of regions in the first image with a plurality of corresponding regions in the second image, a step of determining a search vector for each of the plurality of correspondence regions, a step of identifying a plurality of consistent regions by selecting only a correspondence region having a search vector consistent with the positional information from the plurality of correspondence regions, and a step of performing registration of the first and second images using the plurality of consistent regions.

### SUMMARY OF THE INVENTION

One embodiment according to the disclosed technology provides an imaging control apparatus, an imaging control method, and a program that enable a third imaging target region to be imaged even in a case where overlapping imaging processing fails.

According to a first aspect of the disclosed technology, there is provided an imaging control apparatus comprising a processor, in which the processor is configured to cause an imaging apparatus to image a first imaging target region, in a case where a part of a second imaging target region overlaps with a part of the first imaging target region while a moving object on which the imaging apparatus is mounted is moving, perform overlapping imaging processing of causing the imaging apparatus to image the second imaging target region, and in a case where the overlapping imaging processing fails, perform interval imaging processing of causing the imaging apparatus to image a third imaging target region on a condition that a moving distance by which the moving object moves from a first position at which the first imaging target region is imaged by the imaging apparatus reaches a first predetermined moving distance.

According to a second aspect of the disclosed technology, in the imaging control apparatus according to the first aspect, a case where the overlapping imaging processing fails includes a case where the second imaging target region is not imaged by the imaging apparatus and where the moving distance exceeds a distance from the first position to a second position at which the second imaging target region is to be imaged by the imaging apparatus.

According to a third aspect of the disclosed technology, in the imaging control apparatus according to the first or second aspect, a case where the overlapping imaging processing fails includes a case where the second imaging target region is imaged by the imaging apparatus and where a first overlapping amount by which a part of a first image obtained by imaging the first imaging target region overlaps with a part of a second image obtained by imaging the second imaging target region falls outside a first predetermined range.

According to a fourth aspect of the disclosed technology, in the imaging control apparatus according to any one of the first to third aspects, a case where the overlapping imaging processing fails includes a case where a third image obtained by imaging the second imaging target region via the imaging apparatus does not satisfy predetermined image quality.

According to a fifth aspect of the disclosed technology, in the imaging control apparatus according to any one of the first to fourth aspects, a part of the third imaging target region overlaps with a part of the second imaging target region.

According to a sixth aspect of the disclosed technology, in the imaging control apparatus according to any one of the first to fifth aspects, the first predetermined moving distance is a distance from the first position to a third position at which a part of the third imaging target region overlaps with a part of the second imaging target region.

According to a seventh aspect of the disclosed technology, in the imaging control apparatus according to any one of the first to sixth aspects, the first predetermined moving distance is a distance that is longer by a factor of a natural number greater than or equal to 2 than a distance from the first position to a fourth position at which the second imaging target region is to be imaged by the imaging apparatus.

According to an eighth aspect of the disclosed technology, in the imaging control apparatus according to any one of the first to seventh aspects, the overlapping imaging processing is performed on a condition that a second overlapping amount by which a part of a fourth image obtained by imaging the first imaging target region via the imaging apparatus overlaps with a part of a fifth image obtained by imaging the second imaging target region via the imaging apparatus falls within a second predetermined range.

According to a ninth aspect of the disclosed technology, in the imaging control apparatus according to any one of the first to eighth aspects, the moving distance is derived based on acceleration measured by an acceleration sensor mounted on the imaging apparatus and/or the moving object.

According to a tenth aspect of the disclosed technology, in the imaging control apparatus according to any one of the first to ninth aspects, a determination that the moving distance reaches the first predetermined moving distance is made on a condition that in a case where the moving object moves at a constant speed, a time that elapses from a first timing at which the first imaging target region is imaged by the imaging apparatus reaches a first predetermined time.

According to an eleventh aspect of the disclosed technology, in the imaging control apparatus according to any one of the first to tenth aspects, the moving distance is derived based on a moving speed of the moving object derived based on a plurality of sixth images obtained by imaging performed by the imaging apparatus and on a time interval in a case where the plurality of sixth images are obtained.

According to a twelfth aspect of the disclosed technology, in the imaging control apparatus according to any one of the first to eleventh aspects, the processor is configured to, in a case where the overlapping imaging processing fails, acquire positional information related to a position of the second imaging target region, first image information related to a seventh image obtained by imaging the first imaging target region via the imaging apparatus, and second image information related to an eighth image obtained by imaging the third imaging target region via the imaging apparatus, and the positional information related to the position of the second imaging target region is stored in a memory in association with image information of at least one of the first image information or the second image information.

According to a thirteenth aspect of the disclosed technology, in the imaging control apparatus according to any one of the first to twelfth aspects, the processor is configured to acquire a moving speed of the moving object, and output moving speed data indicating the moving speed, and the moving speed is derived based on a plurality of ninth images obtained by imaging performed by the imaging apparatus.

According to a fourteenth aspect of the disclosed technology, there is provided an imaging control method comprising causing an imaging apparatus to image a first imaging target region, performing, in a case where a part of a second imaging target region overlaps with a part of the first imaging target region while a moving object on which the imaging apparatus is mounted is moving, overlapping imaging processing of causing the imaging apparatus to image the second imaging target region, and performing, in a case where the overlapping imaging processing fails, interval imaging processing of causing the imaging apparatus to image a third imaging target region on a condition that a moving distance by which the moving object moves from a first position at which the first imaging target region is imaged by the imaging apparatus reaches a first predetermined moving distance.

According to a fifteenth aspect of the disclosed technology, there is provided a program causing a computer to execute a process comprising causing an imaging apparatus to image a first imaging target region, performing, in a case where a part of a second imaging target region overlaps with a part of the first imaging target region while a moving object on which the imaging apparatus is mounted is moving, overlapping imaging processing of causing the imaging apparatus to image the second imaging target region, and performing, in a case where the overlapping imaging processing fails, interval imaging processing of causing the imaging apparatus to image a third imaging target region on a condition that a moving distance by which the moving object moves from a first position at which the first imaging target region is imaged by the imaging apparatus reaches a first predetermined moving distance.

### BRIEF DESCRIPTION OF THE DRAWINGS

FIG. 1 is a perspective view illustrating examples of a flying imaging apparatus and a target object.

FIG. 2 is a block diagram illustrating an example of a hardware configuration of an imaging apparatus.

FIG. 3 is a perspective view illustrating examples of the flying imaging apparatus, a first imaging target region, a second imaging target region, and a third imaging target region.

FIG. 4 is a block diagram illustrating an example of a functional configuration of the imaging apparatus for executing imaging processing.

FIG. 5 is a descriptive diagram for describing an example of a first operation of a processor in the imaging processing.

FIG. 6 is a descriptive diagram for describing an example of a second operation of the processor in the imaging processing.

FIG. 7 is a descriptive diagram for describing an example of a third operation of the processor in the imaging processing.

FIG. 8 is a descriptive diagram for describing an example of a fourth operation of the processor in the imaging processing.

FIG. 9 is a descriptive diagram for describing an example of a fifth operation of the processor in the imaging processing.

FIG. 10 is a descriptive diagram for describing an example of a sixth operation of the processor in the imaging processing.

FIG. 11 is a descriptive diagram for describing an example of a seventh operation of the processor in the imaging processing.

FIG. 12 is a descriptive diagram for describing an example of an eighth operation of the processor in the imaging processing.

FIG. 13 is a descriptive diagram for describing an example of a ninth operation of the processor in the imaging processing.

FIG. 14 is a block diagram illustrating an example of a functional configuration of the imaging apparatus for executing re-imaging processing.

FIG. 15 is a descriptive diagram for describing an example of a first operation of the processor in the re-imaging processing.

FIG. 16 is a descriptive diagram for describing an example of a second operation of the processor in the re-imaging processing.

FIG. 17 is a descriptive diagram for describing an example of a third operation of the processor in the re-imaging processing.

FIG. 18 is a descriptive diagram for describing an example of a fourth operation of the processor in the re-imaging processing.

FIG. 19 is a descriptive diagram for describing an example of a fifth operation of the processor in the re-imaging processing.

FIG. 20 is a flowchart illustrating an example of a flow of the imaging processing.

FIG. 21 is a flowchart illustrating an example of a flow of the re-imaging processing.

FIG. 22 is a descriptive diagram for describing a first modification example of the fifth operation of the processor in the imaging processing.

FIG. 23 is a descriptive diagram for describing a first modification example of the seventh operation of the processor in the imaging processing.

FIG. 24 is a descriptive diagram for describing a second modification example of the fifth operation of the processor in the imaging processing.

FIG. 25 is a descriptive diagram for describing a second modification example of the seventh operation of the processor in the imaging processing.

### DESCRIPTION OF THE PREFERRED EMBODIMENTS

Hereinafter, an example of embodiments of an imaging control apparatus, an imaging control method, and a program according to the disclosed technology will be described with reference to the accompanying drawings.

First, terms used in the following description will be described.

I/F refers to the abbreviation for “Interface”. RAM refers to the abbreviation for “Random Access Memory”. EEPROM refers to the abbreviation for “Electrically Erasable Programmable Read-Only Memory”. CPU refers to the abbreviation for “Central Processing Unit”. HDD refers to the abbreviation for “Hard Disk Drive”. SSD refers to the abbreviation for “Solid State Drive”. DRAM refers to the abbreviation for “Dynamic Random Access Memory”. SRAM refers to the abbreviation for “Static Random Access Memory”. CMOS refers to the abbreviation for “Complementary Metal Oxide Semiconductor”. GPU refers to the abbreviation for “Graphics Processing Unit”. TPU refers to the abbreviation for “Tensor Processing Unit”. USB refers to the abbreviation for “Universal Serial Bus”. ASIC refers to the abbreviation for “Application Specific Integrated Circuit”. FPGA refers to the abbreviation for “Field-Programmable Gate Array”. PLD refers to the abbreviation for “Programmable Logic Device”. SoC refers to the abbreviation for “System-on-a-Chip”. IC refers to the abbreviation for “Integrated Circuit”.

In description of the present specification, the term “constant” refers to not only being completely constant but also being constant in a sense of including an error that is generally allowed in the technical field of the disclosed technology and that does not contradict the gist of the disclosed technology. The term “perpendicular” refers to not only being completely perpendicular but also being perpendicular in a sense of including an error that is generally allowed in the technical field of the disclosed technology and that does not contradict the gist of the disclosed technology. In description of the present specification, the term “horizontal direction” refers to not only a complete horizontal direction but also a horizontal direction in a sense of including an error that is generally allowed in the technical field of the disclosed technology and that does not contradict the gist of the disclosed technology. In description of the present specification, the term “vertical direction” refers to not only a complete vertical direction but also a vertical direction in a sense of including an error that is generally allowed in the technical field of the disclosed technology and that does not contradict the gist of the disclosed technology.

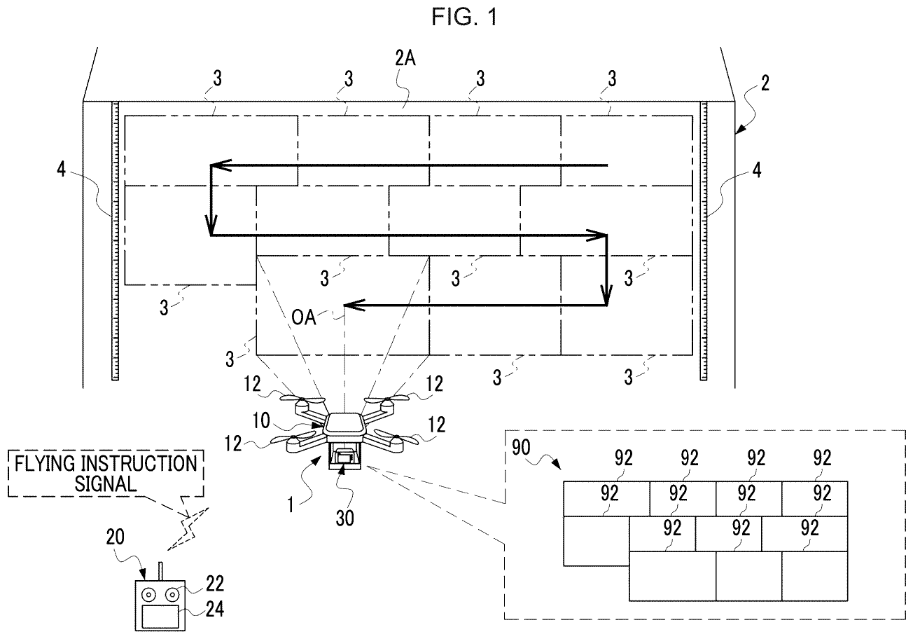

For example, as illustrated in FIG. 1, a flying imaging apparatus 1 comprises a flying function and an imaging function and images a wall surface 2A of a target object 2 while flying. In description of the present specification, a concept of “flying” includes not only a meaning indicating that the flying imaging apparatus 1 moves in the air but also a meaning indicating that the flying imaging apparatus 1 is at a standstill in the air.

For example, the wall surface 2A is a plane. A plane refers to a two-dimensional surface (that is, a surface along a two-dimensional direction). In description of the present specification, a concept of “plane” does not include a meaning of a mirror surface. In the present embodiment, for example, the wall surface 2A is a plane defined in a horizontal direction and a vertical direction (that is, a surface extending in the horizontal direction and the vertical direction). The wall surface 2A has roughness. For example, the roughness includes roughness caused by a material forming the wall surface 2A and roughness caused by loss and/or deficiency. For example, the target object 2 having the wall surface 2A is a pier provided in a bridge. For example, the pier is made of reinforced concrete. While a pier is illustrated as an example of the target object 2, the target object 2 may be an object other than a pier (for example, a tunnel or a dam).

The flying function of the flying imaging apparatus 1 (hereinafter, simply referred to as the “flying function”) is a function of causing the flying imaging apparatus 1 to fly based on a flying instruction signal. The flying instruction signal refers to a signal for instructing the flying imaging apparatus 1 to fly. For example, the flying instruction signal is transmitted from a transmitter 20 for operating the flying imaging apparatus 1. The transmitter 20 is operated by a user (not illustrated). The transmitter 20 comprises an operation unit 22 for operating the flying imaging apparatus 1, and a display device 24 for displaying various images and/or information or the like. For example, the display device 24 is a liquid crystal display.

While an example of transmitting the flying instruction signal the transmitter 20 is illustrated, the flying instruction signal may be transmitted from a base station (not illustrated) or the like that sets a flying route for the flying imaging apparatus 1. The imaging function of the flying imaging apparatus 1 (hereinafter, simply referred to as the “imaging function”) is a function of causing the flying imaging apparatus 1 to image a subject (for example, the wall surface 2A of the target object 2).

The flying imaging apparatus 1 comprises a flying object 10 and an imaging apparatus 30. For example, the flying object 10 is an unmanned aerial vehicle such as a drone. The flying function is implemented by the flying object 10. The flying object 10 includes a plurality of propellers 12, and flies by rotating the plurality of propellers 12. Flying of the flying object 10 is synonymous with flying of the flying imaging apparatus 1. The flying object 10 is an example of a “moving object” according to the disclosed technology.

For example, the imaging apparatus 30 is a digital camera or a video camera. The imaging function is implemented by the imaging apparatus 30. The imaging apparatus 30 is mounted on the flying object 10. Specifically, the imaging apparatus 30 is provided in a lower portion of the flying object 10. While an example of providing the imaging apparatus 30 in the lower portion of the flying object 10 is illustrated, the imaging apparatus 30 may be provided in an upper portion, a front portion, or the like of the flying object 10.

The flying imaging apparatus 1 images a plurality of imaging target regions 3 of the wall surface 2A in order. The imaging target region 3 is a region determined by an angle of view of the flying imaging apparatus 1. In the example illustrated in FIG. 1, a quadrangular region is illustrated as an example of the imaging target region 3. A plurality of combination images 92 are obtained by imaging the plurality of imaging target regions 3 in order via the imaging apparatus 30. A composite image 90 is generated by combining the plurality of combination images 92. The plurality of combination images 92 are combined such that the adjacent combination images 92 partially overlap with each other. Examples of the composite image 90 include a two-dimensional panorama image. The two-dimensional panorama image is merely an example, and a three-dimensional image (for example, a three-dimensional panorama image) may be generated as the composite image 90 in the same manner as generation of the two-dimensional panorama image as the composite image 90.

The composite image 90 may be generated each time the combination image 92 of each of the second and subsequent frames is obtained, or may be generated after the plurality of combination images 92 are obtained for the wall surface 2A. Processing of generating the composite image 90 may be executed by the flying imaging apparatus 1 or may be executed by an external apparatus (not illustrated) communicably connected to the flying imaging apparatus 1. For example, the composite image 90 is used for inspecting or surveying the wall surface 2A of the target object 2.

In the example illustrated in FIG. 1, an aspect of imaging each imaging target region 3 via the imaging apparatus 30 in a state where an optical axis OA of the imaging apparatus 30 is perpendicular to the wall surface 2A is illustrated. The following description will be based on an assumption of an example of imaging each imaging target region 3 via the imaging apparatus 30 in a state where the optical axis OA of the imaging apparatus 30 is perpendicular to the wall surface 2A.

The plurality of imaging target regions 3 are imaged such that the adjacent imaging target regions 3 partially overlap with each other. A purpose of imaging the plurality of imaging target regions 3 such that the adjacent imaging target regions 3 partially overlap with each other is to combine the combination images 92 corresponding to the adjacent imaging target regions 3 based on a feature point included in an overlapping part between the adjacent imaging target regions 3. Hereinafter, each of partial overlapping between the adjacent imaging target regions 3 adjacent to each other and partial overlapping between the adjacent combination images 92 will be referred to as “overlapping”.

For example, the flying imaging apparatus 1 move in a zigzag manner by alternating movement in the horizontal direction and movement in the vertical direction. Accordingly, the plurality of imaging target regions 3 that are contiguous in a zigzag shape are imaged in order. For example, a measuring tape 4 is provided at both ends of the wall surface 2A in the horizontal direction. The measuring tape 4 is hanging down from an upper portion of the target object 2. The measuring tape 4 is provided on both sides of the plurality of imaging target regions 3 in the horizontal direction. The user moves the flying imaging apparatus 1 in the horizontal direction and the vertical direction by operating the flying imaging apparatus 1 based on a scale provided in the measuring tape 4.

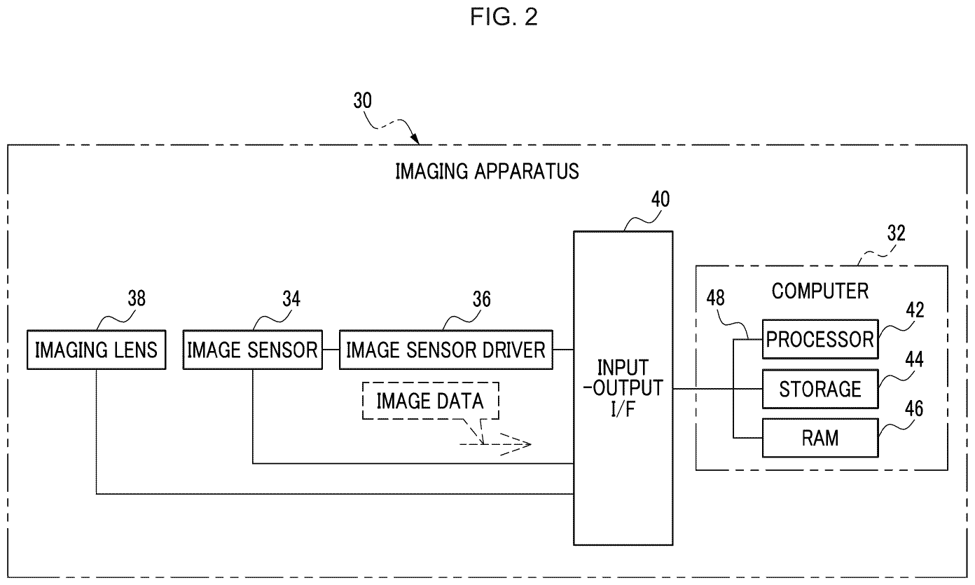

For example, as illustrated in FIG. 2, the imaging apparatus 30 comprises a computer 32, an image sensor 34, an image sensor driver 36, an imaging lens 38, and an input-output I/F 40.

The computer 32 comprises a processor 42, a storage 44, and a RAM 46. The computer 32 is an example of the “imaging control apparatus” and a “computer” according to the disclosed technology. The processor 42 is an example of a “processor” according to the disclosed technology. The processor 42, the storage 44, and the RAM 46 are connected to each other through a bus 48, and the bus 48 is connected to the input-output I/F 40. The image sensor 34, the image sensor driver 36, and the imaging lens 38 are also connected to the input-output I/F 40.

For example, the processor 42 includes a CPU and controls the entire imaging apparatus 30. The storage 44 is a non-volatile storage device that stores various programs and various parameters and the like. Examples of the storage 44 include an HDD and/or a flash memory (for example, an EEPROM and/or an SSD).

The RAM 46 is a memory temporarily storing information and is used as a work memory by the processor 42. Examples of the RAM 46 include a DRAM and/or an SRAM.

The image sensor 34 is connected to the image sensor driver 36. The image sensor driver 36 controls the image sensor 34 in accordance with an instruction from the processor 42. For example, the image sensor 34 is a CMOS image sensor. While a CMOS image sensor is illustrated as the image sensor 34, the disclosed technology is not limited to this, and other image sensors may be used. The image sensor 34 images the subject (for example, the wall surface 2A of the target object 2) and outputs image data obtained by imaging under control of the image sensor driver 36.

The imaging lens 38 is disposed on a side closer to the subject (a side closer to the object) than the image sensor 34. The imaging lens 38 receives subject light that is reflected light from the subject, and forms an image of the received subject light on an imaging surface of the image sensor 34. The imaging lens 38 includes a plurality of optical elements (not illustrated) such as a focus lens, a zoom lens, and a stop. The imaging lens 38 is connected to the computer 32 through the input-output I/F 40. Specifically, the plurality of optical elements included in the imaging lens 38 are connected to the input-output I/F 40 through a drive mechanism (not illustrated) including a motive power source. The plurality of optical elements included in the imaging lens 38 operate under control of the computer 32. In the imaging apparatus 30, focusing, optical zooming, and adjustment and the like of exposure are implemented by operating the plurality of optical elements (for example, various lenses and the stop) included in the imaging lens 38.

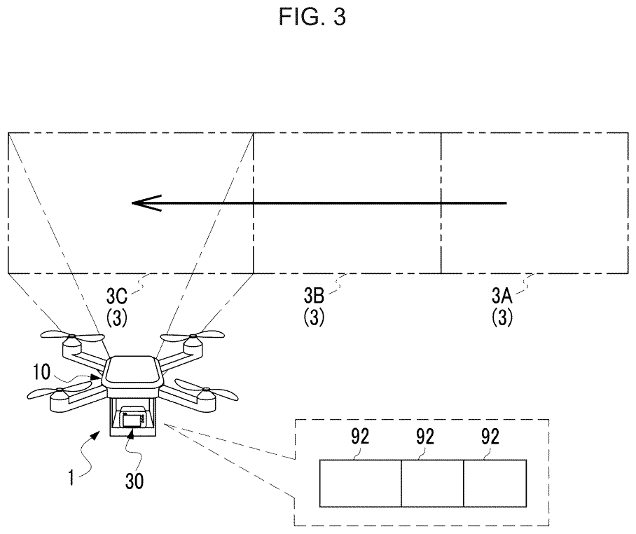

For example, FIG. 3 illustrates a first imaging target region 3A, a second imaging target region 3B, and a third imaging target region 3C that are contiguous in the horizontal direction among the plurality of imaging target regions 3. A part of the first imaging target region 3A overlaps with a part of the second imaging target region 3B, and a part of the second imaging target region 3B overlaps with a part of the third imaging target region 3C.

The flying imaging apparatus 1 performs imaging at a timing at which it is determined that a predetermined imaging condition is established. Examples of the predetermined imaging condition include a condition that an overlapping amount by which the adjacent imaging target regions 3 partially overlap with each other falls within a predetermined range. The predetermined range is set considering efficiency in a case of imaging the plurality of imaging target regions 3 in order, the number of feature points required for combining the adjacent combination images 92, and the like.

In a case where positioning of the flying imaging apparatus 1 is stable and where the flying imaging apparatus 1 is normally moving, the second imaging target region 3B is imaged in a case where a part of the second imaging target region 3B overlaps with a part of the first imaging target region 3A, and the third imaging target region 3C is imaged in a case where a part of the third imaging target region 3C overlaps with a part of the second imaging target region 3B. Accordingly, the first imaging target region 3A, the second imaging target region 3B, and the third imaging target region 3C are imaged in order by the flying imaging apparatus 1.

For example, in a case where the flying imaging apparatus 1 is moving, positioning of the flying imaging apparatus 1 may be unstable because of disturbance such as wind acting on the flying imaging apparatus 1. For example, in a case where positioning of the flying imaging apparatus 1 is unstable, it is assumed that the flying imaging apparatus 1 fails to perform processing of imaging the second imaging target region 3B after imaging the first imaging target region 3A (hereinafter, referred to as “overlapping imaging processing”). Examples of failure of the overlapping imaging processing include an example in which a distance from a position at which the first imaging target region 3A is imaged to a position at which the second imaging target region 3B is to be imaged exceeds a moving distance of the flying imaging apparatus 1 before it is determined that the predetermined imaging condition is established.

It is considered to cause the flying imaging apparatus 1 to image the third imaging target region 3C on a condition that the overlapping imaging processing for the second imaging target region 3B succeeds. However, in this case, a problem arises in that the third imaging target region 3C cannot be imaged (that is, imaging for the third imaging target region 3C cannot continue) in a case where the overlapping imaging processing for the second imaging target region 3B fails. Therefore, the processor 42 executes the following imaging processing in order to resolve the problem.

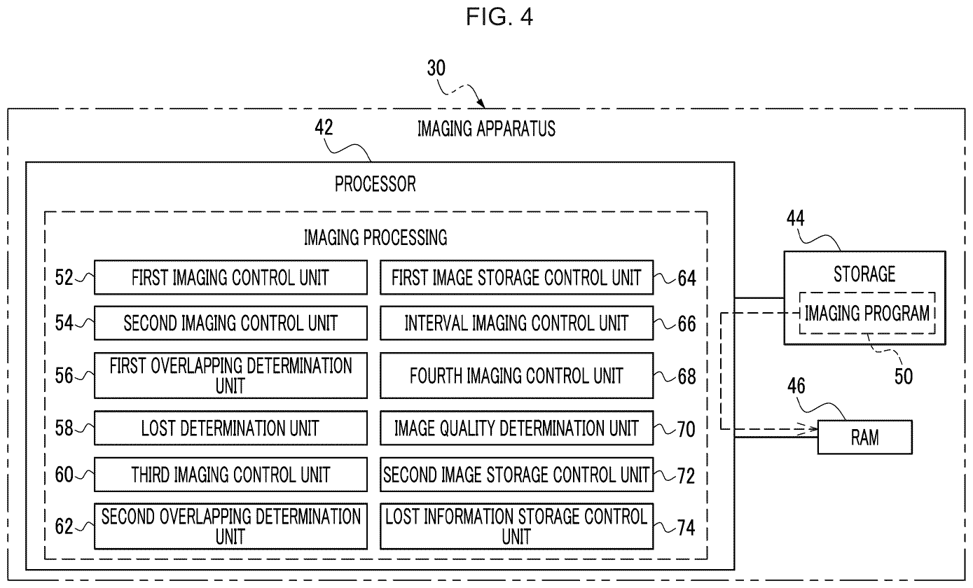

For example, as illustrated in FIG. 4, the storage 44 stores an imaging program 50. The imaging program 50 is an example of the “program” according to the disclosed technology. The processor 42 reads out the imaging program 50 from the storage 44 and executes the read imaging program 50 on the RAM 46. The processor 42 performs the imaging processing in accordance with the imaging program 50 executed on the RAM 46.

The imaging processing starts each time the flying imaging apparatus 1 starts moving in the horizontal direction. Hereinafter, for example, an example in which the flying imaging apparatus 1 receives the flying instruction signal for moving at a constant speed from the transmitter 20 (refer to FIG. 1) and in which the flying imaging apparatus 1 starts moving in the horizontal direction will be described.

The imaging processing is implemented by causing the processor 42 to operate as a first imaging control unit 52, a second imaging control unit 54, a first overlapping determination unit 56, a lost determination unit 58, a third imaging control unit 60, a second overlapping determination unit 62, a first image storage control unit 64, an interval imaging determination unit 66, a fourth imaging control unit 68, an image quality determination unit 70, a second image storage control unit 72, and a lost information storage control unit 74 in accordance with the imaging program 50.

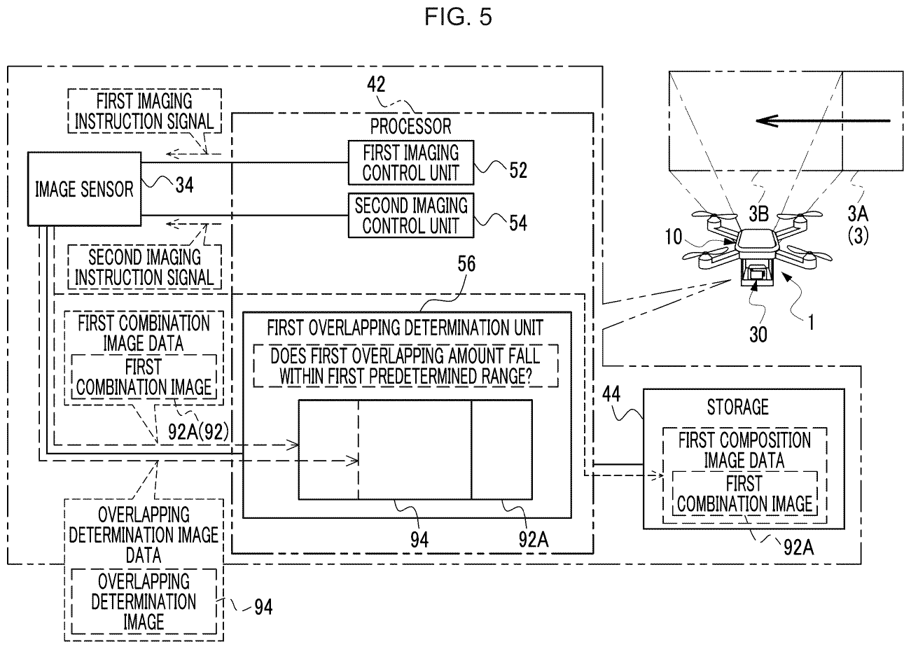

For example, as illustrated in FIG. 5, in a case where the flying imaging apparatus 1 starts moving in the horizontal direction, the first imaging control unit 52 causes the image sensor 34 to image the first imaging target region 3A that is the first imaging target region 3 by outputting a first imaging instruction signal to the image sensor 34. First combination image data is obtained by imaging the first imaging target region 3A under control of the first imaging control unit 52. The first combination image data is image data indicating a first combination image 92A that is the combination image 92 corresponding to the first imaging target region 3A. The first combination image data is stored in the storage 44. The first imaging target region 3A is an example of a “first imaging target region” according to the disclosed technology. The first combination image 92A is an example of a “first image” according to the disclosed technology.

The second imaging control unit 54 causes the image sensor 34 to image the second imaging target region 3B by outputting a second imaging instruction signal to the image sensor 34 while the flying imaging apparatus 1 is moving. Accordingly, overlapping determination image data is obtained. The overlapping determination image data is image data indicating an overlapping determination image 94. For example, the overlapping determination image 94 may be a display image (for example, a live view image or a postview image), and the overlapping determination image data may be output to a display device (not illustrated) comprised in the imaging apparatus 30 and/or the display device 24 (refer to FIG. 1) comprised in the transmitter 20.

Hereinafter, “imaging” will refer to imaging for obtaining the combination image 92 unless a description of “imaged under control of the second imaging control unit 54” is present.

The first overlapping determination unit 56 determines whether or not an area (hereinafter, referred to as a “first overlapping amount”) of an overlapping region in which a part of the first combination image 92A overlaps with a part of the overlapping determination image 94 falls within a first predetermined range.

The first predetermined range is set considering the efficiency in a case of imaging the plurality of imaging target regions 3 in order, the number of feature points required for combining the adjacent combination images 92 (refer to FIG. 1), and the like. For example, an upper limit value of the first predetermined range is set to a value of 50% or lower of an area of the combination image 92 considering the efficiency in a case of imaging the plurality of imaging target regions 3 in order. For example, a lower limit value of the first predetermined range is set to a value of 30% or higher of the area of the combination image 92 considering the number of feature points required for combining the adjacent combination images 92 and the like.

A moving speed of the flying object 10 is set to a speed at which determination of the first overlapping determination unit 56 is performed at least once from falling of the first overlapping amount below the upper limit value of the first predetermined range to falling of the first overlapping amount below the lower limit value of the first predetermined range.

The first overlapping amount is an example of a “second overlapping amount” according to the disclosed technology. The first predetermined range is an example of a “second predetermined range” according to the disclosed technology. The first combination image 92A is an example of a “fourth image” according to the disclosed technology. The overlapping determination image 94 is an example of a “fifth image” according to the disclosed technology.

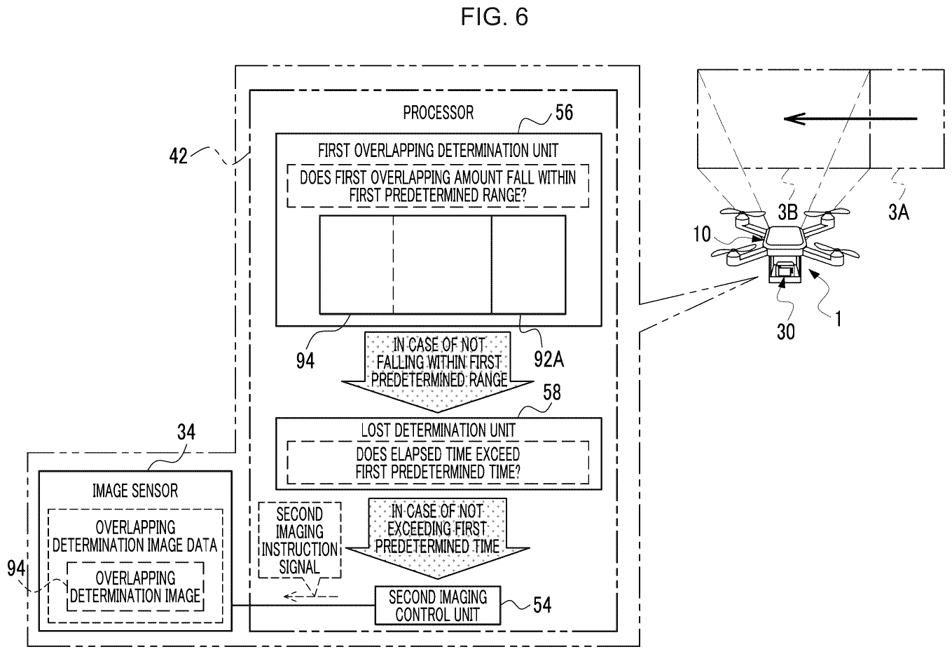

For example, FIG. 6 illustrates an example in which the first overlapping amount falls above the upper limit value of the first predetermined range. In a case where the first overlapping amount falls above the upper limit value of the first predetermined range, the first overlapping determination unit 56 determines that the first overlapping amount does not fall within the first predetermined range.

In a case where the first overlapping determination unit 56 determines that the first overlapping amount does not fall within the first predetermined range, the lost determination unit 58 determines whether or not a time (hereinafter, referred to as an “elapsed time”) that elapses from a first timing at which the first imaging target region 3A is imaged exceeds a first predetermined time. For example, the first predetermined time is set to a time from imaging of the first imaging target region 3A to reaching of the first overlapping amount to the lower limit value of the first predetermined range, in a case where the flying imaging apparatus 1 moves at a constant speed.

For example, FIG. 6 illustrates an example in which the elapsed time does not exceed the first predetermined time. In a case where the lost determination unit 58 determines that the elapsed time does not exceed the first predetermined time, the second imaging control unit 54 causes the image sensor 34 to image the second imaging target region 3B by outputting the second imaging instruction signal to the image sensor 34. Accordingly, new overlapping determination image data is obtained.

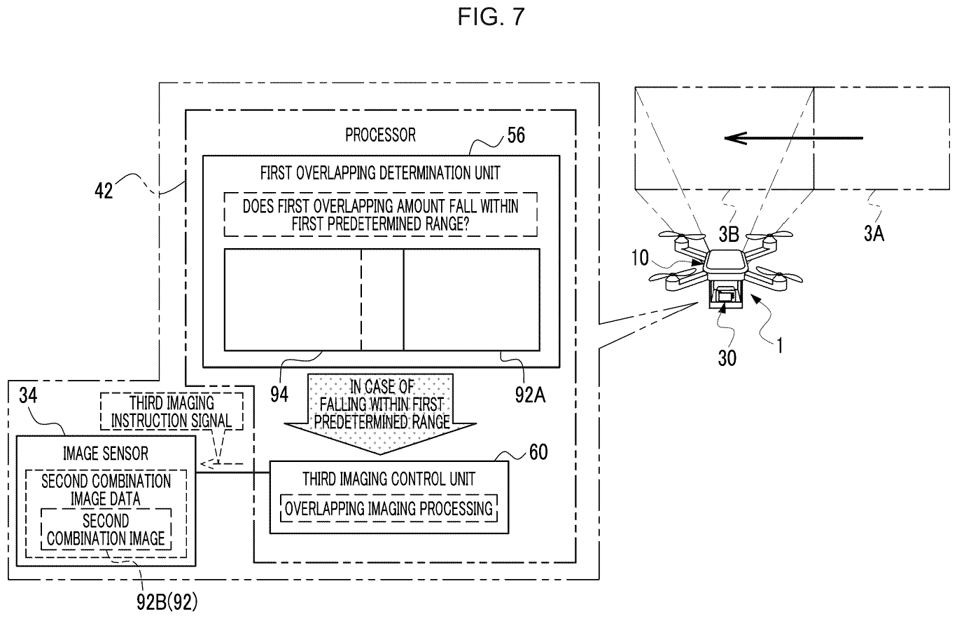

For example, FIG. 7 illustrates an example in which the first overlapping amount falls within the first predetermined range. In a case where the first overlapping determination unit 56 determines that the first overlapping amount falls within the first predetermined range, the third imaging control unit 60 executes the overlapping imaging processing. That is, the third imaging control unit 60 causes the image sensor 34 to image the second imaging target region 3B by outputting a third imaging instruction signal to the image sensor 34. Second combination image data is obtained by imaging the second imaging target region 3B under control of the third imaging control unit 60. The second combination image data is image data indicating a second combination image 92B that is the combination image 92 corresponding to the second imaging target region 3B. The second imaging target region 3B is an example of a “second imaging target region” according to the disclosed technology. The second combination image 92B is an example of a “second image” according to the disclosed technology.

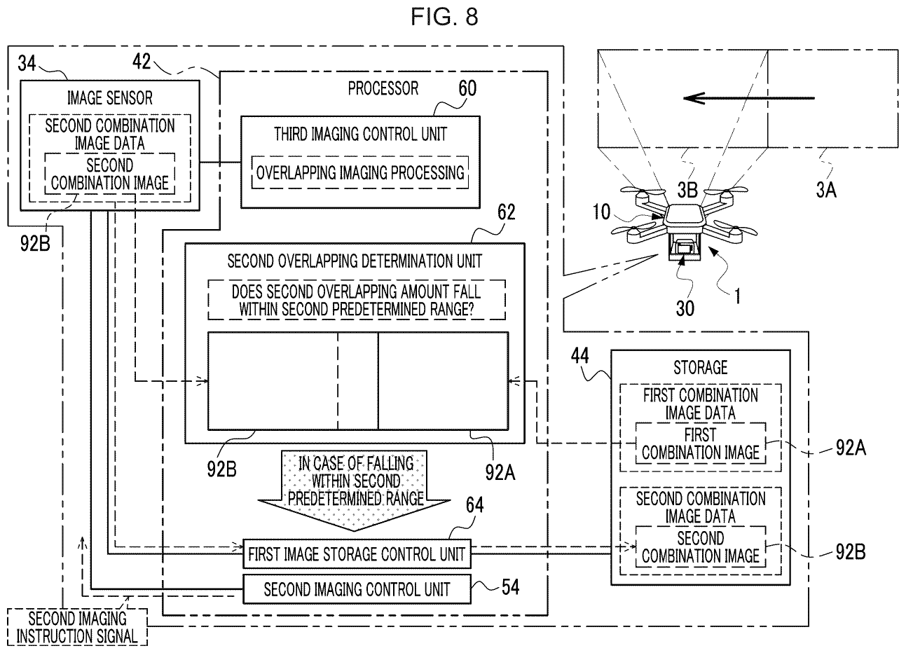

For example, as illustrated in FIG. 8, the second overlapping determination unit 62 determines whether or not an area (hereinafter, referred to as a “second overlapping amount”) of an overlapping region in which a part of the first combination image 92A overlaps with a part of the second combination image 92B falls within a second predetermined range. For example, the second predetermined range is set to have the same upper limit value and the same lower limit value as the first predetermined range. The second predetermined range may be set to have a different upper limit value and a different lower limit value from the first predetermined range. The second overlapping amount is an example of a “first overlapping amount” according to the disclosed technology. The second predetermined range is an example of a “first predetermined range” according to the disclosed technology.

Examples of a factor that causes the second overlapping amount to exceed the upper limit value of the second predetermined range after determination of the first overlapping determination unit 56 is performed include an increase in the second overlapping amount caused by a change in a direction of the flying imaging apparatus 1 because of disturbance such as wind after determination of the first overlapping determination unit 56 is performed. In a case where the second combination image data is stored in the storage 44 regardless of the fact that the second overlapping amount exceeds the upper limit value of the second predetermined range, the number of pieces of combination image data stored in the storage 44 is increased compared to that in a case where the second combination image data is stored in the storage 44 on a condition that the second overlapping amount falls within the second predetermined range. Therefore, in the present embodiment, the upper limit value of the second predetermined range is set in order to suppress the number of pieces of combination image data stored in the storage 44.

Examples of a factor that causes the second overlapping amount to exceed the upper limit value of the second predetermined range after determination of the first overlapping determination unit 56 is performed also include a decrease in the second overlapping amount caused by a change in the direction of the flying imaging apparatus 1 because of disturbance such as wind after determination of the first overlapping determination unit 56 is performed, or a decrease in the second overlapping amount caused by occurrence of a delay from output of the third imaging instruction signal to the image sensor 34 by the third imaging control unit 60 to imaging performed by the image sensor 34. In a case where the second combination image data is stored in the storage 44 regardless of the fact that the second overlapping amount falls below the lower limit value of the second predetermined range, the number of feature points required for combining the adjacent combination images 92 may be insufficient. Therefore, in the present embodiment, the lower limit value of the second predetermined range is set in order to secure the number of feature points required for combining the adjacent combination images 92.

For example, FIG. 8 illustrates an example in which the second overlapping amount falls within the second predetermined range. In a case where the second overlapping determination unit 62 determines that the second overlapping amount falls within the second predetermined range, the first image storage control unit 64 outputs the second combination image data to the storage 44. Accordingly, the second combination image data is stored in the storage 44.

In a case where the second combination image data is stored in the storage 44 by the first image storage control unit 64, the second imaging target region 3B subsequently imaged under control of the third imaging control unit 60 is handled as the first imaging target region 3A, and the second combination image data obtained by imaging the second imaging target region 3B under control of the third imaging control unit 60 is handled as the first combination image data.

In a case where the second combination image data is stored in the storage 44 by the first image storage control unit 64, the second imaging control unit 54 causes the image sensor 34 to image a new second imaging target region 3B by outputting the second imaging instruction signal to the image sensor 34. Accordingly, new overlapping determination image data is obtained.

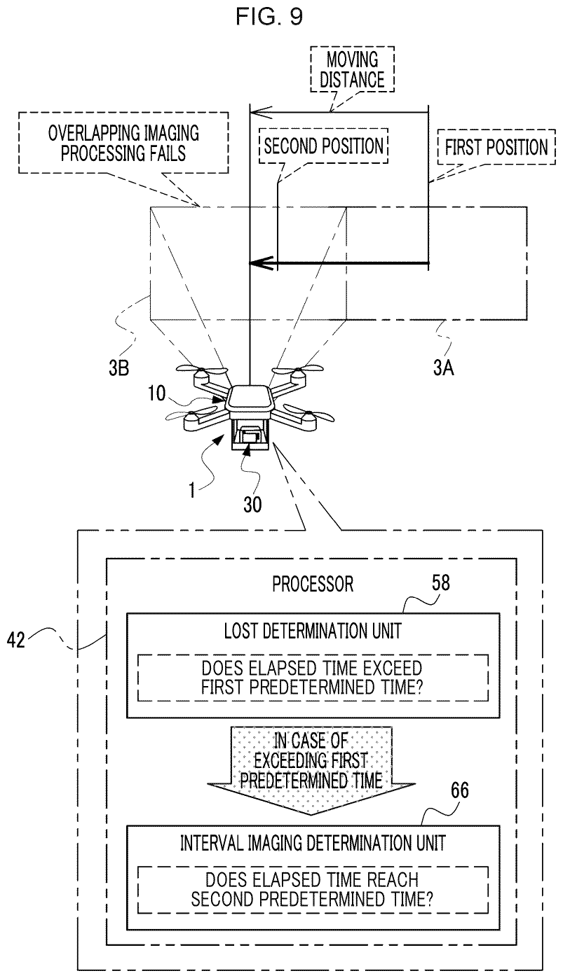

For example, FIG. 9 illustrates an example in which the elapsed time exceeds the first predetermined time. A first position indicates a position of a center of the flying imaging apparatus 1 in a case where the first imaging target region 3A is imaged. A second position indicates the position of the center of the flying imaging apparatus 1 in a case where the first overlapping amount by which a part of the first combination image 92A (refer to FIG. 7) overlaps with a part of the overlapping determination image 94 (refer to FIG. 7) reaches the lower limit value of the first predetermined range. The first position is an example of a “first position” according to the disclosed technology. The second position is an example of a “second position” according to the disclosed technology.

In a case where the elapsed time exceeds the first predetermined time, the moving distance by which the flying imaging apparatus 1 moves from the first position exceeds a distance from the first position to the second position. In this case, since an opportunity to image the second imaging target region 3B is lost, the imaging apparatus 30 fails to perform the overlapping imaging processing. That is, this means that the second combination image 92B corresponding to the second imaging target region 3B is lost as one of images used for generating the composite image 90.

In a case where the lost determination unit 58 determines that the elapsed time exceeds the first predetermined time, the interval imaging determination unit 66 determines whether or not the elapsed time reaches a second predetermined time. For example, in a case where the second predetermined time is denoted by T2, the second predetermined time T2 is determined by Expression (1) below in a case where the flying imaging apparatus 1 moves at a constant speed.

$$\begin{matrix}[ Expression 1 ] & \\ T 2 = T 1 + T 3 & ( 1 )\end{matrix}$$

T1 denotes the first predetermined time. As described above, for example, the first predetermined time is set to the time from imaging of the first imaging target region 3A to reaching of the first overlapping amount to the lower limit value of the first predetermined range. T3 denotes a third predetermined time. For example, the third predetermined time is set to the same time as a time from imaging of the first imaging target region 3A to reaching of the first overlapping amount to the upper limit value of the first predetermined range. In a case where the flying imaging apparatus 1 moves at a constant speed, the flying imaging apparatus 1 reaches a position at which the third imaging target region 3C (refer to FIG. 3) can be imaged, in a case where the elapsed time reaches the second predetermined time. The second predetermined time is an example of a “first predetermined time” according to the disclosed technology.

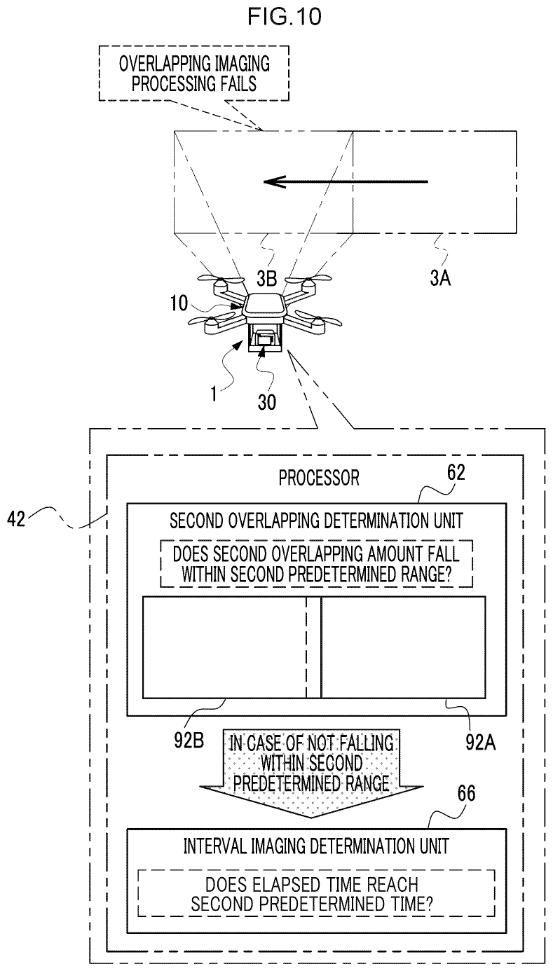

For example, FIG. 10 illustrates an example in which the second overlapping amount falls outside the second predetermined range (specifically, the second overlapping amount falls below the lower limit value of the second predetermined range). In a case where the second overlapping amount falls below the lower limit value of the second predetermined range, the first combination image 92A and the second combination image 92B may not be combined based on a feature point included in a part of the first combination image 92A as an image and a feature point included in a part of the second combination image 92B as an image. In this case, since the second combination image 92B that may be combined with the first combination image 92A cannot be obtained, the imaging apparatus 30 fails to perform the overlapping imaging processing. That is, this means that the second combination image 92B corresponding to the second imaging target region 3B is lost as one of images used for generating the composite image 90.

In a case where the second overlapping determination unit 62 determines that the second overlapping amount does not fall within the second predetermined range, the interval imaging determination unit 66 determines whether or not the elapsed time reaches the second predetermined time.

In the above description, examples of a case where the overlapping imaging processing fails include a case where the elapsed time exceeds the first predetermined time and a case where the second overlapping amount falls outside the second predetermined range. However, for example, a case where the overlapping imaging processing fails may also include other cases such as a case where it is determined that the imaging apparatus 30 does not perform imaging because a certain condition (for example, an out-of-focus condition under a situation where an autofocus mode is set as an operation mode for the imaging apparatus 30) is satisfied, or a case where the combination image data is not normally stored in the storage 44.

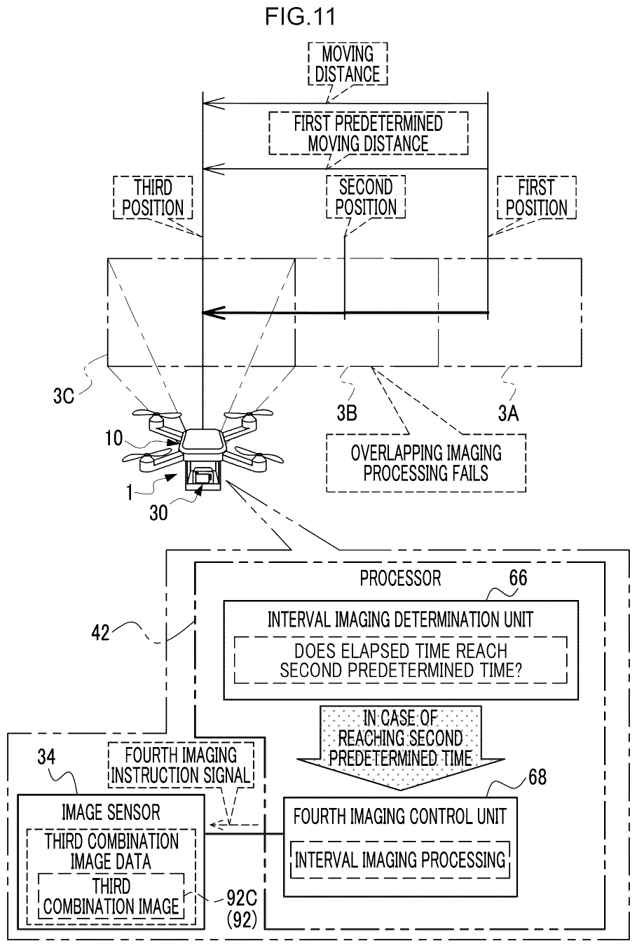

For example, FIG. 11 illustrates an example in which the elapsed time reaches the second predetermined time. In a case where the elapsed time reaches the second predetermined time, the moving distance by which the flying imaging apparatus 1 moves from the first position reaches a first predetermined moving distance. A third position indicates the position of the center of the flying imaging apparatus 1 in a case where the elapsed time reaches the second predetermined time. The first predetermined moving distance is a distance from the first position to the third position. For example, the first predetermined moving distance is a distance that is twice as long as the distance from the first position to the second position. The first predetermined moving distance is an example of a “first predetermined moving distance” according to the disclosed technology. The third position is an example of a “third position” according to the disclosed technology. The second position is an example of a “fourth position” according to the disclosed technology.

In a case where the interval imaging determination unit 66 determines that the elapsed time reaches the second predetermined time, the fourth imaging control unit 68 executes interval imaging processing. That is, the fourth imaging control unit 68 causes the image sensor 34 to image the third imaging target region 3C by outputting a fourth imaging instruction signal to the image sensor 34. Third combination image data is obtained by imaging the third imaging target region 3C under control of the fourth imaging control unit 68. The third combination image data is image data indicating a third combination image 92C that is the combination image 92 corresponding to the third imaging target region 3C. The third imaging target region 3C is an example of a “third imaging target region” according to the disclosed technology.

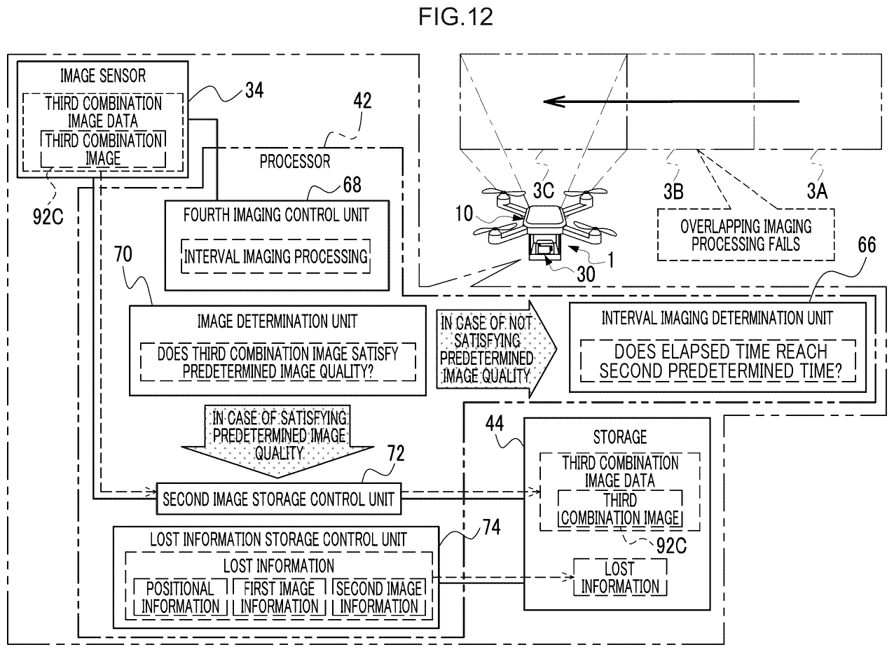

For example, as illustrated in FIG. 12, the image quality determination unit 70 determines whether or not the third combination image 92C satisfies predetermined image quality. For example, the predetermined image quality is set based on a blurriness amount, exposure, an artifact (for example, a geometric, illuminance-related, or color-related artifact) and/or a shake amount. The fact that the third combination image 92C does not satisfy the predetermined image quality means that a feature point (that is, a matching feature point between images) needed for generating the composite image 90 cannot be extracted from the third combination image 92C. In a case where the third combination image 92C does not satisfy the predetermined image quality, the third combination image 92C cannot be obtained as one of images needed for generating the composite image 90. Thus, the imaging apparatus 30 fails to perform the interval imaging processing.

In a case where the image quality determination unit 70 determines that the third combination image 92C does not satisfy the predetermined image quality, the interval imaging determination unit 66 determines whether or not the elapsed time reaches the second predetermined time again.

For example, the second predetermined time T2 in a case where the interval imaging processing fails in addition to the overlapping imaging processing is determined by Expression (2) below in a case where the flying imaging apparatus 1 moves at a certain speed.

$$\begin{matrix}[ Expression 2 ] & \\ T 2 = T 1 \times N + T 3 & ( 2 )\end{matrix}$$

T1 denotes the first predetermined time. As described above, for example, the first predetermined time is set to the time from imaging of the first imaging target region 3A to reaching of the first overlapping amount to the lower limit value of the first predetermined range. N denotes a natural number indicating the number of times the overlapping imaging processing and the interval imaging processing fail. T3 denotes the third predetermined time. For example, as described above, the third predetermined time is set to the same time as the time from imaging of the first imaging target region 3A to reaching of the first overlapping amount to the upper limit value of the first predetermined range.

In a case where the image quality determination unit 70 determines that the third combination image 92C satisfies the predetermined image quality, the second image storage control unit 72 outputs the third combination image data to the storage 44. Accordingly, the third combination image data is stored in the storage 44.

The lost information storage control unit 74 acquires positional information related to a position of the second imaging target region 3B (hereinafter, referred to as a “lost position”) in a case where the overlapping imaging processing or the interval imaging processing fails, first image information related to the first combination image 92A, and second image information related to the third combination image 92C.

For example, the positional information related to the lost position is information indicating an order of imaging of the second imaging target region 3B corresponding to the lost position counted from the first imaging target region 3 (refer to FIG. 5). For example, the first image information related to the first combination image 92A is identification information with which the first combination image 92A corresponding to the first imaging target region 3A imaged immediately previous to the second imaging target region 3B corresponding to the lost position can be identified. For example, the second image information related to the third combination image 92C is identification information with which the third combination image 92C corresponding to the third imaging target region 3C imaged through the interval imaging processing can be identified.

The lost information storage control unit 74 generates lost information in which the positional information is associated with the first image information and with the second image information, and stores the lost information in the storage 44. The positional information may be associated with only one of the first image information or the second image information. The positional information is an example of “positional information” according to the disclosed technology. The first image information is an example of “first image information” according to the disclosed technology. The second image information is an example of “second image information” according to the disclosed technology. The storage 44 is an example of a “memory” according to the disclosed technology. The first combination image 92A is an example of a “seventh image” according to the disclosed technology. The third combination image 92C is an example of an “eighth image” according to the disclosed technology.

In a case where the lost information is stored in the storage 44 by the lost information storage control unit 74, the third imaging target region 3C subsequently imaged under control of the fourth imaging control unit 68 is handled as the first imaging target region 3A, and the third combination image data obtained by imaging the third imaging target region 3C under control of the fourth imaging control unit 68 is handled as the first combination image data.

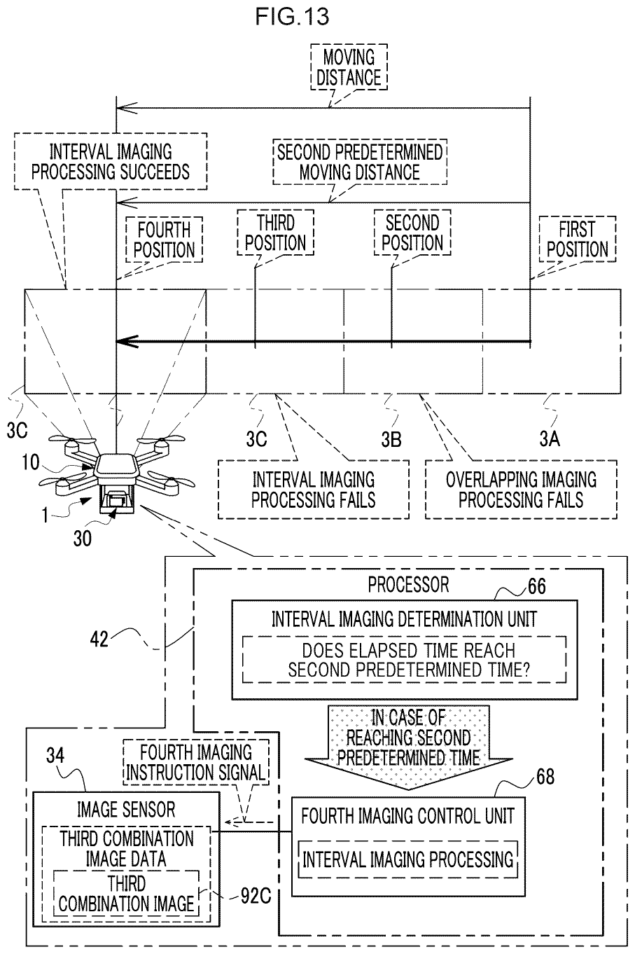

For example, FIG. 13 illustrates an example in which the overlapping imaging processing and the interval imaging processing for the first time fail consecutively and in which the interval imaging processing for the second time succeeds. In the example illustrated in FIG. 13, the overlapping imaging processing and the interval imaging processing for the first time fail consecutively, and then the interval imaging processing for the second time is executed by the fourth imaging control unit 68 by determining that the elapsed time reaches the second predetermined time via the interval imaging determination unit 66.

In a case where the interval imaging processing for the second time is executed, the moving distance by which the flying imaging apparatus 1 moves from the first position reaches a second predetermined moving distance. A fourth position indicates the position of the center of the flying imaging apparatus 1 in a case where the elapsed time reaches the second predetermined time. The second predetermined moving distance is a distance from the first position to the fourth position. For example, the second predetermined moving distance is a distance that is three times longer than the distance from the first position to the second position. The second predetermined moving distance is an example of the “first predetermined moving distance” according to the disclosed technology. The fourth position is an example of the “third position” according to the disclosed technology. The second position is an example of the “fourth position” according to the disclosed technology.

In the example illustrated in FIG. 13, the second combination image data corresponding to the overlapping imaging processing and the third combination image data corresponding to the interval imaging processing for the first time are not obtained, and the first combination image data corresponding to the first imaging target region 3A and the third combination image data corresponding to the interval imaging processing for the second time are obtained.

In the example illustrated in FIG. 13, the first imaging target region 3A imaged immediately before the second imaging target region 3B corresponding to the overlapping imaging processing can be perceived as an example of the “first imaging target region” according to the disclosed technology. The second imaging target region 3B corresponding to the overlapping imaging processing can be perceived as an example of the “second imaging target region” according to the disclosed technology. The third imaging target region 3C corresponding to the interval imaging processing for the first time can be perceived as an example of the “third imaging target region” according to the disclosed technology.

In the example illustrated in FIG. 13, the second imaging target region 3B corresponding to the overlapping imaging processing can also be perceived as an example of the “first imaging target region” according to the disclosed technology. The third imaging target region 3C corresponding to the interval imaging processing for the first time can also be perceived as an example of the “second imaging target region” according to the disclosed technology. The third imaging target region 3C corresponding to the interval imaging processing for the second time can also be perceived as an example of the “third imaging target region” according to the disclosed technology. In this case, the interval imaging processing for the first time is an example of “overlapping imaging processing” according to the disclosed technology. A factor that causes the interval imaging processing for the first time to fail may be such that the third combination image 92C obtained by imaging the third imaging target region 3C corresponding to the interval imaging processing for the first time via the imaging apparatus 30 does not satisfy the predetermined image quality. In this case, the third combination image 92C is an example of a “third image” according to the disclosed technology.

As described above, in a case where the overlapping imaging processing fails and where the interval imaging processing succeeds, the second imaging target region 3B from which the combination image data cannot be obtained is present between the third imaging target region 3C corresponding to the interval imaging processing that has succeeded and the first imaging target region 3A. In a case where the second imaging target region 3B from which the combination image data cannot be obtained is present, a problem arises in that a missing region occurs in a part of the composite image 90 (refer to FIG. 1) generated by combining the plurality of combination images 92. Therefore, the processor 42 executes the following re-imaging processing in order to resolve the problem.

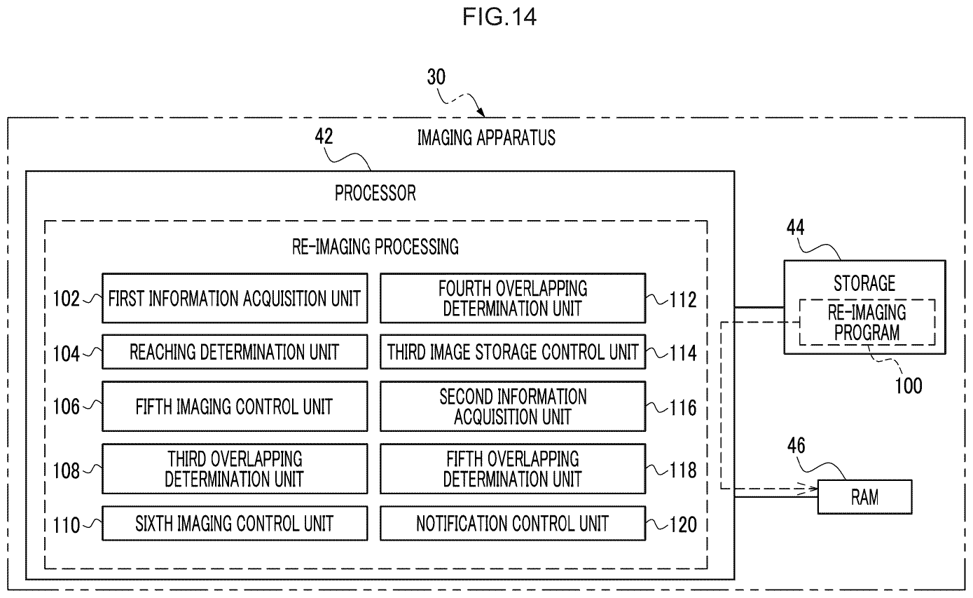

For example, as illustrated in FIG. 14, the storage 44 stores a re-imaging program 100. The processor 42 reads out the re-imaging program 100 from the storage 44 and executes the read re-imaging program 100 on the RAM 46. The processor 42 performs the re-imaging processing in accordance with the re-imaging program 100 executed on the RAM 46.

In the re-imaging processing, the flying imaging apparatus 1 starts moving in the horizontal direction from the same position as the position in a case where the imaging processing is started. In the re-imaging processing, the flying imaging apparatus 1 moves at the same moving speed as the moving speed in the imaging processing. The re-imaging processing starts in a case where the flying imaging apparatus 1 starts moving in the horizontal direction.

The re-imaging processing is implemented by causing the processor 42 to operate as a first information acquisition unit 102, a reaching determination unit 104, a fifth imaging control unit 106, a third overlapping determination unit 108, a sixth imaging control unit 110, a fourth overlapping determination unit 112, a third image storage control unit 114, a second information acquisition unit 116, a fifth overlapping determination unit 118, and a notification control unit 120 in accordance with the re-imaging program 100.

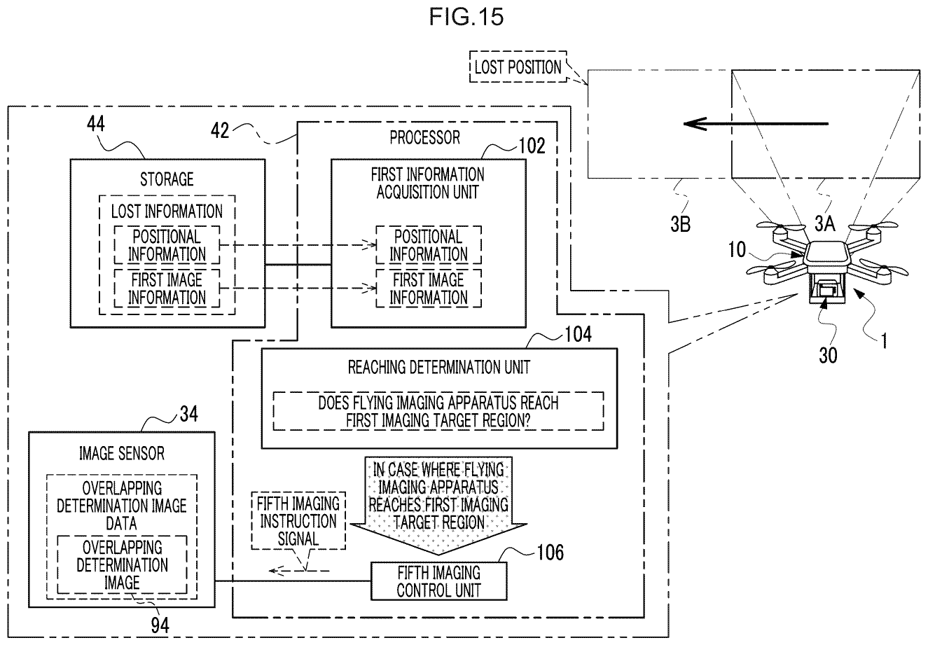

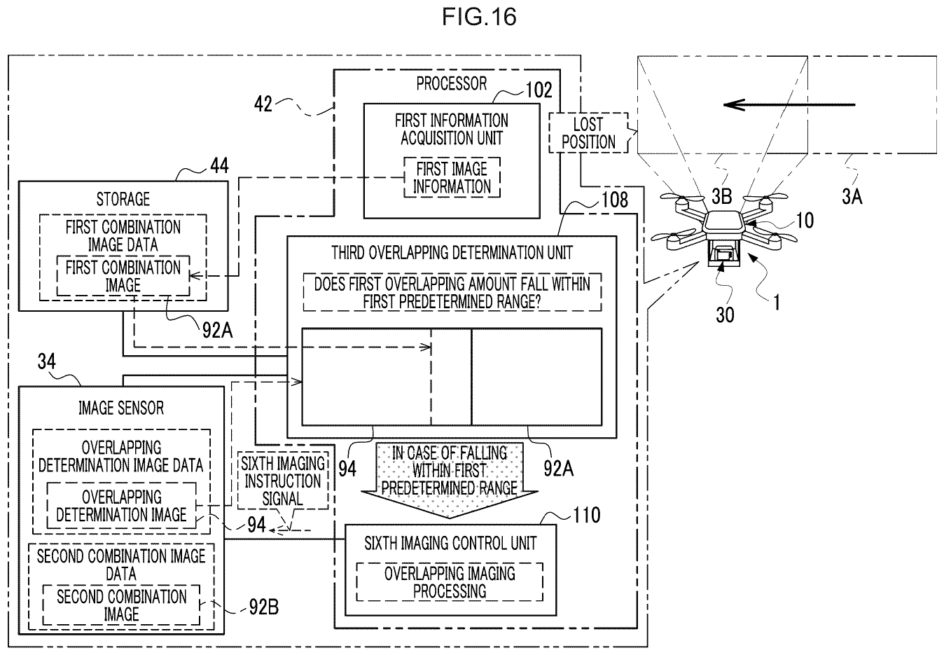

For example, as illustrated in FIG. 15, the first information acquisition unit 102 acquires positional information related to the position of the second imaging target region 3B corresponding to the lost position and the first image information related to the first combination image 92A from the lost information stored in the storage 44. For example, the order of imaging of the second imaging target region 3B corresponding to the lost position counted from the first imaging target region 3 (refer to FIG. 5) is specified based on the positional information. For example, the first combination image 92A (refer to FIG. 16) corresponding to the first imaging target region 3A imaged immediately before the second imaging target region 3B corresponding to the lost position is specified based on the first image information related to the first combination image 92A.

The reaching determination unit 104 determines whether or not the flying imaging apparatus 1 reaches the first imaging target region 3A (hereinafter, referred to as the “first imaging target region 3A immediately before the lost position”) imaged immediately before the second imaging target region 3B corresponding to the lost position. For example, in a case where a required time required from the start of the re-imaging processing to reaching of the flying imaging apparatus 1 to the first imaging target region 3A immediately before the lost position is denoted by T4, the required time T4 is determined by Expression (3) below in a case where the flying imaging apparatus 1 moves at a constant speed.

$$\begin{matrix}[ Expression 3 ] & \\ T 4 = T 1 \times ( M - 2 ) & ( 3 )\end{matrix}$$

T1 denotes the first predetermined time. As described above, for example, the first predetermined time is set to the time from imaging of the first imaging target region 3A to reaching of the first overlapping amount to the lower limit value of the first predetermined range. M denotes a natural number greater than or equal to 2 indicating the order of imaging of the second imaging target region 3B corresponding to the lost position counted from the first imaging target region 3.

In a case where the reaching determination unit 104 determines that the flying imaging apparatus 1 reaches the first imaging target region 3A immediately before the lost position, the fifth imaging control unit 106 causes the image sensor 34 to image the second imaging target region 3B by outputting a fifth imaging instruction signal to the image sensor 34. Accordingly, the overlapping determination image data is obtained.

For example, as illustrated in FIG. 16, the third overlapping determination unit 108 determines whether or not the first overlapping amount by which a part of the first combination image 92A specified by the first image information overlaps with a part of the overlapping determination image 94 falls within the first predetermined range. The first predetermined range is the same as the first predetermined range in the imaging processing.

For example, FIG. 16 illustrates an example in which the first overlapping amount falls within the first predetermined range. In a case where the third overlapping determination unit 108 determines that the first overlapping amount falls within the first predetermined range, the sixth imaging control unit 110 executes the overlapping imaging processing. The overlapping imaging processing is the same as the overlapping imaging processing in the imaging processing. That is, the sixth imaging control unit 110 causes the image sensor 34 to image the second imaging target region 3B by outputting a sixth imaging instruction signal to the image sensor 34. Accordingly, the second combination image data indicating the second combination image 92B corresponding to the lost position is obtained.

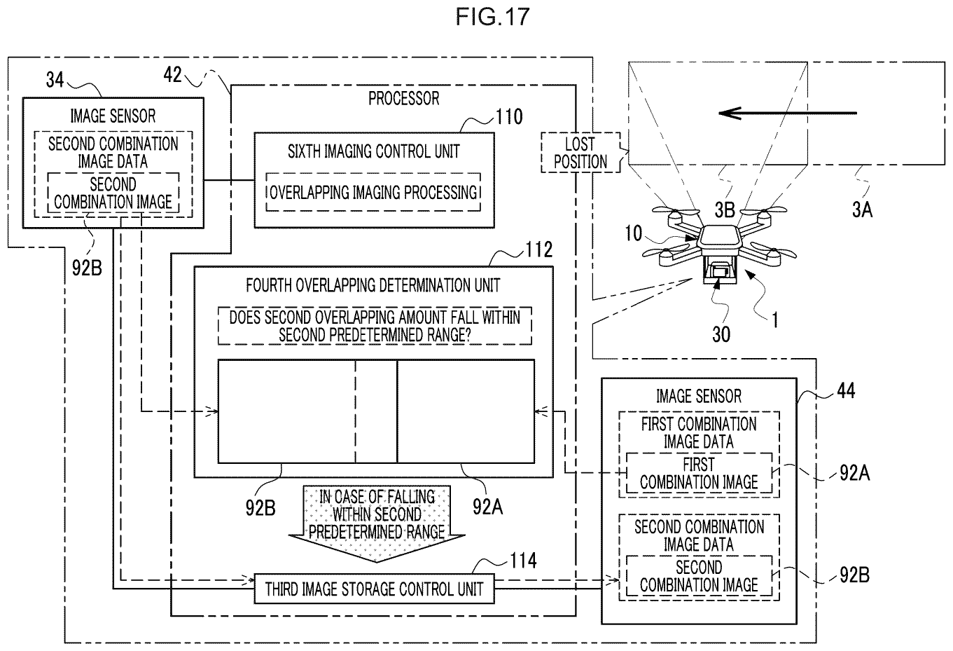

For example, as illustrated in FIG. 17, the fourth overlapping determination unit 112 determines whether or not the second overlapping amount by which a part of the first combination image 92A overlaps with a part of the second combination image 92B falls within the second predetermined range. The second overlapping amount is the same as the second overlapping amount in the imaging processing, and the second predetermined range is the same as the second predetermined range in the imaging processing.

For example, FIG. 17 illustrates an example in which the second overlapping amount falls within the second predetermined range. In a case where the fourth overlapping determination unit 112 determines that the second overlapping amount falls within the second predetermined range, the third image storage control unit 114 outputs the second combination image data to the storage 44. Accordingly, the second combination image data is stored in the storage 44.

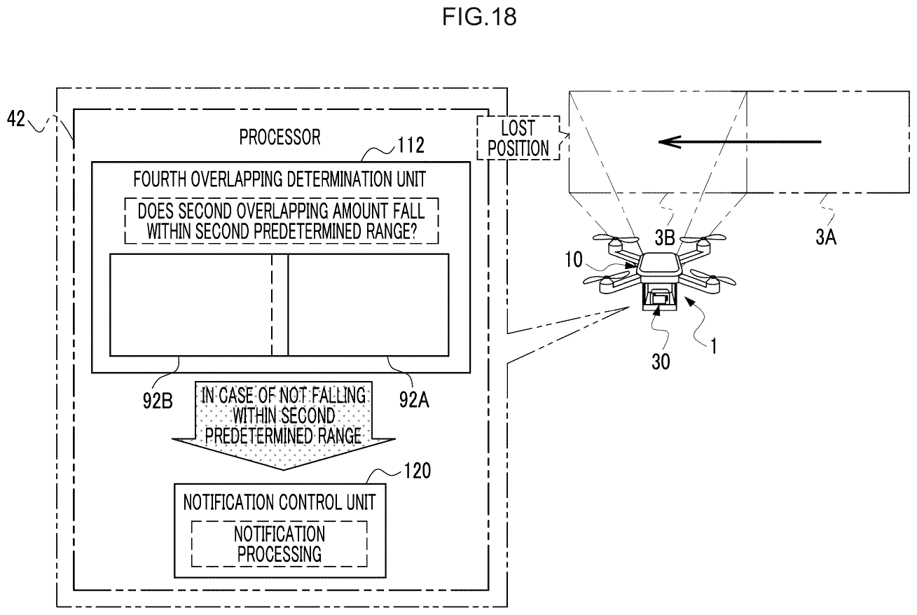

For example, FIG. 18 illustrates an example in which the second overlapping amount falls outside the second predetermined range (specifically, the second overlapping amount falls below the lower limit value of the second predetermined range). In a case where the fourth overlapping determination unit 112 determines that the second overlapping amount does not fall within the second predetermined range, the notification control unit 120 performs notification processing. Examples of the notification processing include processing of operating a notification device (not illustrated) comprised in the imaging apparatus 30 and/or the transmitter 20. Examples of the notification device include a speaker, a lighting device, or a display device. Examples of content of notification performed by the notification device include content that prompts the user to perform the re-imaging processing again.

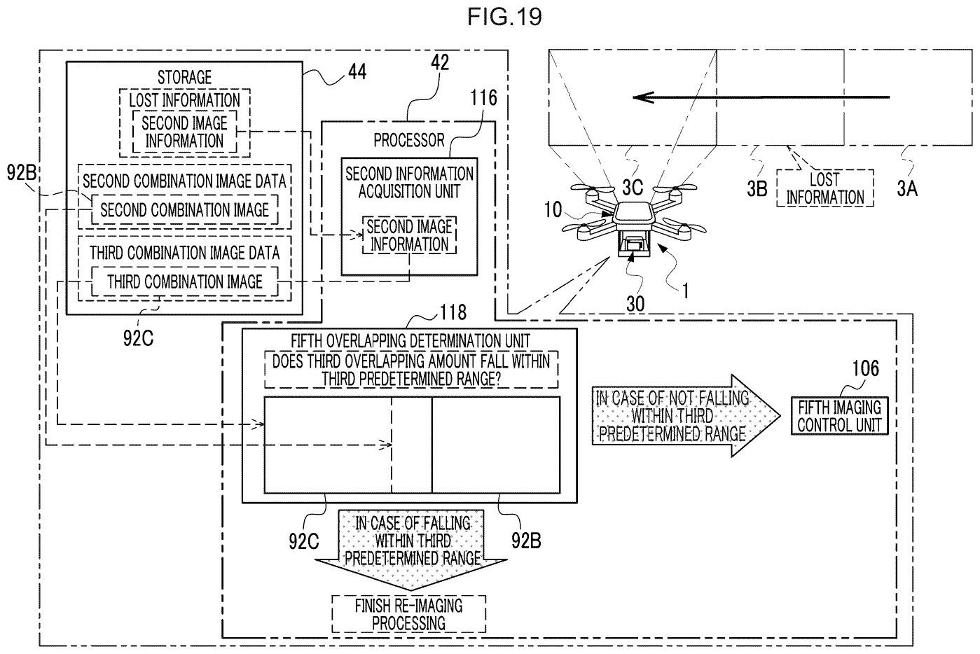

For example, as illustrated in FIG. 19, the second information acquisition unit 116 acquires the second image information related to the third combination image 92C from the lost information stored in the storage 44. For example, the third combination image 92C corresponding to the third imaging target region 3C imaged through the interval imaging processing is specified based on the second image information related to the third combination image 92C.

The fifth overlapping determination unit 118 determines whether or not an area (hereinafter, referred to as a “third overlapping amount”) of an overlapping region in which a part of the second combination image 92B overlaps with a part of the third combination image 92C falls within a third predetermined range. The third overlapping amount is the same as the second overlapping amount in the imaging processing, and the third predetermined range is the same as the second predetermined range in the imaging processing.

For example, FIG. 18 illustrates an example in which the third overlapping amount falls within the third predetermined range. In a case where the third overlapping amount falls within the third predetermined range, the second imaging target region 3B between the first imaging target region 3A and the third imaging target region 3C is sufficiently imaged. Accordingly, in this case, the re-imaging processing is finished.

Meanwhile, in a case where the third overlapping amount falls outside the third predetermined range, the fifth overlapping determination unit 118 determines that the third overlapping amount does not fall within the third predetermined range. In this case, the second imaging target region 3B that is not imaged is present between the first imaging target region 3A and the third imaging target region 3C. Accordingly, in this case, processing performed by the fifth imaging control unit 106, the third overlapping determination unit 108, the sixth imaging control unit 110, the fourth overlapping determination unit 112, the third image storage control unit 114, the second information acquisition unit 116, and the fifth overlapping determination unit 118 is executed again.

In a case where the fifth overlapping determination unit 118 determines that the third overlapping amount does not fall within the third predetermined range, the second imaging target region 3B imaged under control of the sixth imaging control unit 110 is handled as the first imaging target region 3A, and the second combination image data obtained by imaging the second imaging target region 3B under control of the sixth imaging control unit 110 is handled as the first combination image data.

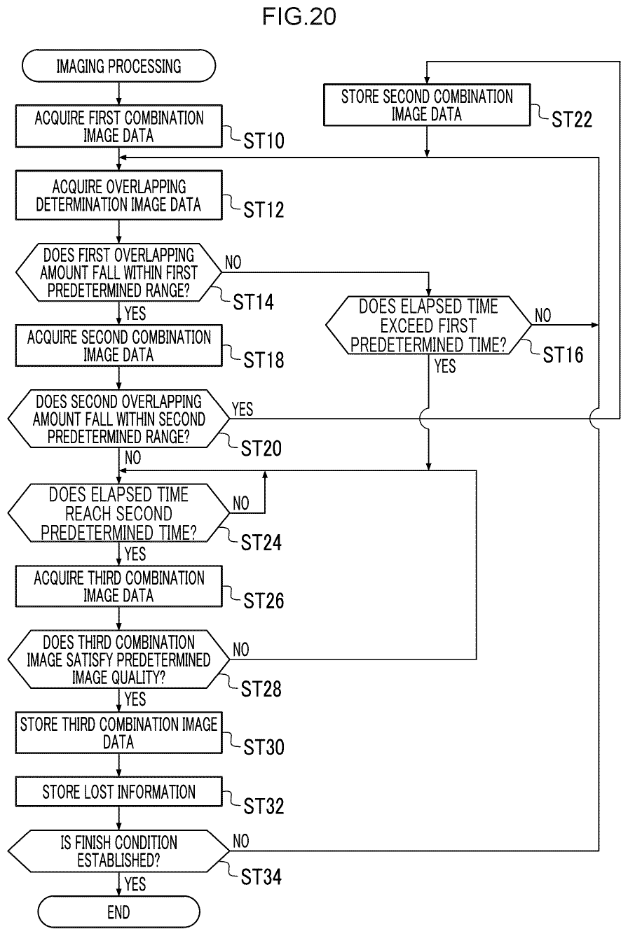

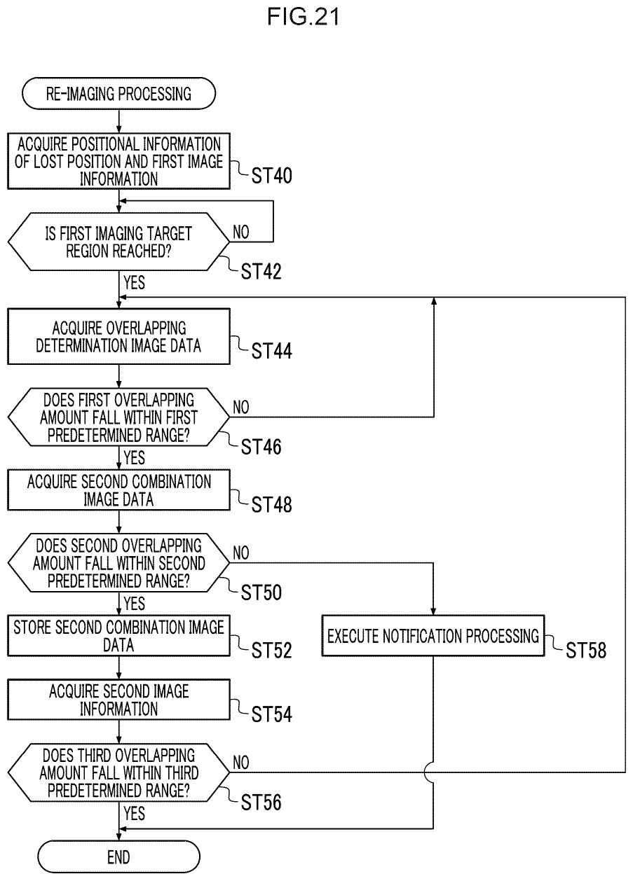

Next, an action of the flying imaging apparatus 1 according to the present embodiment will be described with reference to FIGS. 20 and 21. FIG. 20 illustrates an example of a flow of the imaging processing according to the present embodiment, and FIG. 21 illustrates an example of a flow of the re-imaging processing according to the present embodiment. First, the imaging processing illustrated in FIG. 20 will be described.

In the imaging processing illustrated in FIG. 20, first, in step ST10, the first imaging control unit 52 causes the image sensor 34 to image the first imaging target region 3A that is the first imaging target region 3 (refer to FIG. 5). Accordingly, the first combination image data indicating the first combination image 92A is obtained. After processing in step ST10 is executed, the imaging processing transitions to step ST12.

In step ST12, the second imaging control unit 54 causes the image sensor 34 to image the second imaging target region 3B (refer to FIG. 5). Accordingly, the overlapping determination image data indicating the overlapping determination image 94 is obtained. After processing in step ST12 is executed, the imaging processing transitions to step ST14.

In step ST14, the first overlapping determination unit 56 determines whether or not the first overlapping amount by which a part of the first combination image 92A obtained in step ST10 overlaps with a part of the overlapping determination image 94 obtained in step ST12 falls within the first predetermined range (refer to FIG. 5). In step ST14, in a case where the first overlapping amount falls outside the first predetermined range, a negative determination is made, and the imaging processing transitions to step ST16. In step ST14, in a case where the first overlapping amount falls within the first predetermined range, a positive determination is made, and the imaging processing transitions to step ST18.

In step ST16, the lost determination unit 58 determines whether or not the elapsed time that elapses from the first timing at which the first imaging target region 3A is imaged in step ST10 exceeds the first predetermined time (refer to FIG. 6). In step ST16, in a case where the elapsed time does not exceed the first predetermined time, a negative determination is made, and the imaging processing transitions to step ST12. In step ST16, in a case where the elapsed time exceeds the first predetermined time (that is, in a case where the overlapping imaging processing for the second imaging target region 3B fails), a positive determination is made, and the imaging processing transitions to step ST24.

In step ST18, the third imaging control unit 60 causes the image sensor 34 to image the second imaging target region 3B (refer to FIG. 7). Accordingly, the overlapping imaging processing is executed, and the second combination image data indicating the second combination image 92B is obtained. After processing in step ST18 is executed, the imaging processing transitions to step ST20.

In step ST20, the second overlapping determination unit 62 determines whether or not the second overlapping amount by which a part of the first combination image 92A obtained in step ST10 overlaps with a part of the second combination image 92B obtained in step ST18 falls within the second predetermined range (refer to FIG. 8). In step ST20, in a case where the second overlapping amount falls within the second predetermined range, a positive determination is made, and the imaging processing transitions to step ST22. In step ST20, in a case where the second overlapping amount falls outside the second predetermined range (that is, in a case where the overlapping imaging processing for the second imaging target region 3B fails), a negative determination is made, and the imaging processing transitions to step ST24.

In step ST22, the first image storage control unit 64 stores the second combination image data obtained in step ST18 in the storage 44 (refer to FIG. 8). After processing in step ST22 is executed, the imaging processing transitions to step ST12. In a case where the second combination image data is stored in the storage 44 in step ST22, the second imaging target region 3B imaged in step ST18 is handled as the first imaging target region 3A, and the second combination image data obtained in step ST18 is handled as the first combination image data.

In step ST24, the interval imaging determination unit 66 determines whether or not the elapsed time reaches the second predetermined time (refer to FIGS. 9 and 10). In step ST24, in a case where the elapsed time has not reached the second predetermined time, a negative determination is made, and processing in step ST24 is executed again. In step ST24, in a case where the elapsed time reaches the second predetermined time, a positive determination is made, and the imaging processing transitions to step ST26.

In step ST26, the fourth imaging control unit 68 causes the image sensor 34 to image the third imaging target region 3C (refer to FIG. 11). Accordingly, the interval imaging processing is executed, and the third combination image data indicating the third combination image 92C is obtained. After processing in step ST26 is executed, the imaging processing transitions to step ST28.

In step ST28, the image quality determination unit 70 determines whether or not the third combination image 92C obtained in step ST26 satisfies the predetermined image quality (refer to FIG. 12). In step ST26, in a case where the third combination image 92C satisfies the predetermined image quality, a positive determination is made, and the imaging processing transitions to step ST30. In step ST28, in a case where the third combination image 92C does not satisfy the predetermined image quality (that is, in a case where the interval imaging processing for the third imaging target region 3C fails), a negative determination is made, and the imaging processing transitions to step ST24.

In step ST30, the second image storage control unit 72 stores the third combination image data obtained in step ST26 in the storage 44 (refer to FIG. 12). After processing in step ST30 is executed, the imaging processing transitions to step ST32.

In step ST32, the lost information storage control unit 74 acquires the positional information related to the position of the second imaging target region 3B corresponding to the lost position in a case where the overlapping imaging processing or the interval imaging processing fails, the first image information related to the first combination image 92A obtained in step ST10 or step ST18, and the second image information related to the third combination image 92C obtained in step ST26 (refer to FIG. 12). The lost information in which the positional information is associated with the first image information and with the second image information is generated, and the lost information is stored in the storage 44 (refer to FIG. 12). In a case where the lost information is stored in the storage 44 in step ST32, the third imaging target region 3C subsequently imaged in step ST26 is handled as the first imaging target region 3A, and the third combination image data obtained in step ST26 is handled as the first combination image data.

In step ST34, the processor 42 determines whether or not a condition (finish condition) under which the imaging processing is finished is established. Examples of the finish condition include a condition that the user instructs the imaging apparatus 30 to finish the imaging processing, or a condition that the number of combination images 92 reaches a number designated by the user. In step ST34, in a case where the finish condition is not established, a negative determination is made, and the imaging processing transitions to step ST12. In step ST34, in a case where the finish condition is established, a positive determination is made, and the imaging processing is finished.

Next, the re-imaging processing illustrated in FIG. 21 will be described.

In the re-imaging processing illustrated in FIG. 21, first, in step ST40, the first information acquisition unit 102 acquires the positional information related to the position of the second imaging target region 3B corresponding to the lost position and the first image information related to the first combination image 92A corresponding to the first imaging target region 3A immediately before the lost position, from the lost information stored in the storage 44 (refer to FIG. 15). After processing in step ST40 is executed, the re-imaging processing transitions to step ST42.

In step ST42, the reaching determination unit 104 determines whether or not the flying imaging apparatus 1 reaches the first imaging target region 3A immediately before the lost position (refer to FIG. 15). In step ST42, in a case where the flying imaging apparatus 1 has not reached the first imaging target region 3A immediately before the lost position, processing in step ST42 is executed again. In step ST42, in a case where the flying imaging apparatus 1 reaches the first imaging target region 3A immediately before the lost position, the re-imaging processing transitions to step ST44.

In step ST44, the fifth imaging control unit 106 causes the image sensor 34 to image the second imaging target region 3B. Accordingly, the overlapping determination image data indicating the overlapping determination image 94 is obtained. After processing in step ST44 is executed, the re-imaging processing transitions to step ST46.

In step ST46, the third overlapping determination unit 108 determines whether or not the first overlapping amount by which a part of the first combination image 92A specified by the first image information obtained in step ST40 overlaps with a part of the overlapping determination image 94 obtained in step ST44 falls within the first predetermined range (refer to FIG. 16). In step ST46, in a case where the first overlapping amount falls outside the first predetermined range, a negative determination is made, and the re-imaging processing transitions to step ST44. In step ST46, in a case where the first overlapping amount falls within the first predetermined range, a positive determination is made, and the re-imaging processing transitions to step ST48.

In step ST48, the sixth imaging control unit 110 causes the image sensor 34 to image the second imaging target region 3B (refer to FIG. 16). Accordingly, the overlapping imaging processing is executed, and the second combination image data indicating the second combination image 92B is obtained. After processing in step ST48 is executed, the re-imaging processing transitions to step ST50.

In step ST50, the fourth overlapping determination unit 112 determines whether or not the second overlapping amount by which a part of the first combination image 92A specified by the first image information obtained in step ST40 overlaps with a part of the second combination image 92B obtained in step ST48 falls within the second predetermined range (refer to FIG. 17). In step ST50, in a case where the second overlapping amount falls within the second predetermined range, a positive determination is made, and the re-imaging processing transitions to step ST52. In step ST50, in a case where the second overlapping amount falls outside the second predetermined range (that is, in a case where the overlapping imaging processing for the second imaging target region 3B fails), a negative determination is made, and the re-imaging processing proceeds to step ST58.

In step ST52, the third image storage control unit 114 stores the second combination image data obtained in step ST48 in the storage 44 (refer to FIG. 17). After processing in step ST52 is executed, the re-imaging processing transitions to step ST54.

In step ST54, the second information acquisition unit 116 acquires the second image information related to the third combination image 92C from the lost information stored in the storage 44 (refer to FIG. 19). After processing in step ST54 is executed, the re-imaging processing transitions to step ST56.

In step ST56, the fifth overlapping determination unit 118 determines whether or not the third overlapping amount by which a part of the second combination image 92B obtained in step ST48 overlaps with a part of the third combination image 92C specified by the second image information obtained in step ST54 falls within the third predetermined range (refer to FIG. 19). In step ST56, in a case where the third overlapping amount falls outside the third predetermined range, a negative determination is made, and the re-imaging processing transitions to step ST44. In a case where a negative determination is made in step ST56 and where the re-imaging processing transitions to step ST44, the second imaging target region 3B subsequently imaged in step ST48 is handled as the first imaging target region 3A, and the second combination image data obtained in step ST48 is handled as the first combination image data. In step ST50, in a case where the third overlapping amount falls within the third predetermined range, a positive determination is made, and the re-imaging processing is finished.

In step ST58, the notification control unit 120 performs the notification processing (refer to FIG. 18). After processing in step ST58 is executed, the re-imaging processing is finished.

The imaging control method described as the action of the flying imaging apparatus 1 is an example of the “imaging control method” according to the disclosed technology.

As described above, in the flying imaging apparatus 1 according to the present embodiment, the processor 42 causes the imaging device 30 to image the first imaging target region 3A and, in a case where a part of the second imaging target region 3B overlaps with a part of the first imaging target region 3A while the flying imaging apparatus 1 is moving, performs the overlapping imaging processing of causing the imaging apparatus 30 to image the second imaging target region 3B (refer to FIGS. 5 to 8). In a case where the overlapping imaging processing fails, the processor 42 performs the interval imaging processing of causing the imaging apparatus 30 to image the third imaging target region 3C on a condition that the moving distance by which the flying imaging apparatus 1 moves from the first position at which the first imaging target region 3A is imaged by the imaging apparatus 30 reaches the first predetermined moving distance (refer to FIGS. 9 to 11). Accordingly, even in a case where the overlapping imaging processing fails, the third imaging target region 3C can be imaged. That is, the imaging processing can continue even in a case where the overlapping imaging processing fails.

A case where the overlapping imaging processing fails includes a case where the second imaging target region 3B is not imaged by the imaging apparatus 30 (that is, the second imaging target region 3B is not imaged yet) and where the moving distance of the flying imaging apparatus 1 exceeds the distance from the first position to the second position at which the second imaging target region 3B is to be imaged (refer to FIG. 9). Accordingly, even in a case where the overlapping imaging processing fails because the moving distance exceeds the distance from the first position to the second position, the third imaging target region 3C can be imaged.

A case where the overlapping imaging processing fails includes a case where the second imaging target region 3B is imaged by the imaging apparatus 30 and where the second overlapping amount by which a part of the first combination image 92A obtained by imaging the first imaging target region 3A overlaps with a part of the second combination image 92B obtained by imaging the second imaging target region 3B falls outside the second predetermined range (refer to FIG. 10). Accordingly, even in a case where the overlapping imaging processing fails because the second overlapping amount falls outside the second predetermined range, the third imaging target region 3C can be imaged.

A part of the third imaging target region 3C overlaps with a part of the second imaging target region 3B (refer to FIG. 11). Accordingly, for example, in a case where the second combination image 92B is obtained by imaging the second imaging target region 3B in the re-imaging processing (refer to FIG. 17), a part of the third combination image 92C corresponding to the third imaging target region 3C can be caused to overlap with a part of the second combination image 92B corresponding to the second imaging target region 3B.

The first predetermined moving distance is a distance from the first position to the third position at which a part of the third imaging target region 3C overlaps with a part of the second imaging target region 3B (refer to FIG. 11). Accordingly, in a case where the interval imaging processing is performed on a condition that the moving distance by which the flying imaging apparatus 1 moves from the first position reaches the first predetermined moving distance, the third imaging target region 3C can be imaged such that a part of the third imaging target region 3C overlaps with a part of the second imaging target region 3B.

The first predetermined moving distance is a distance that is longer by a factor of a natural number greater than or equal to 2 than the distance from the first position to the second position at which the second imaging target region 3B is to be imaged. For example, in a case where the natural number greater than or equal to 2 is 2 (refer to FIG. 11), a space corresponding to one second imaging target region 3B is present between the first imaging target region 3A and the third imaging target region 3C in a case where the interval imaging processing is performed. Accordingly, for example, in the re-imaging processing, the plurality of combination images 92 that are contiguous in a moving direction of the flying imaging apparatus 1 can be obtained by imaging the second imaging target region 3B at the second position.

For example, in a case where the natural number greater than or equal to 2 is 3 (refer to FIG. 13), a space corresponding to two imaging target regions 3 is present between the first imaging target region 3A and the third imaging target region 3C in a case where the interval imaging processing is performed. Accordingly, for example, in the re-imaging processing, the plurality of combination images 92 that are contiguous in the moving direction of the flying imaging apparatus 1 can be obtained by imaging the imaging target region 3 at the second position and at the third position (that is, a position separated from the second position by the distance from the first position to the second position).

The overlapping imaging processing is performed on a condition that the first overlapping amount by which a part of the first combination image 92A obtained by imaging the first imaging target region 3A overlaps with a part of the overlapping determination image 94 obtained by imaging the second imaging target region 3B falls within the first predetermined range (refer to FIG. 7). Accordingly, the second overlapping amount by which a part of the second combination image 92B obtained through the overlapping imaging processing overlaps with a part of the first combination image 92A can be caused to fall within the second predetermined range.

A determination that the moving distance reaches the first predetermined moving distance is made on a condition that the time that elapses from the first timing at which the first imaging target region 3A is imaged by the imaging apparatus 30 reaches the first predetermined time in a case where the flying imaging apparatus 1 moves at a constant speed (refer to FIG. 11). Accordingly, the interval imaging processing can be executed based on the time that elapses from the first timing.

In a case where the overlapping imaging processing fails, the processor 42 acquires the positional information related to the position of the second imaging target region 3B, the first image information related to the first combination image 92A, and the second image information related to the third combination image 92C (refer to FIG. 12). The positional information related to the position of the second imaging target region 3B is stored in the storage 44 in association with the first image information and with the second image information. Accordingly, the plurality of combination images 92 that are contiguous in the moving direction of the flying imaging apparatus 1 can be obtained by executing the re-imaging processing based on the positional information, the first image information, and the second image information.

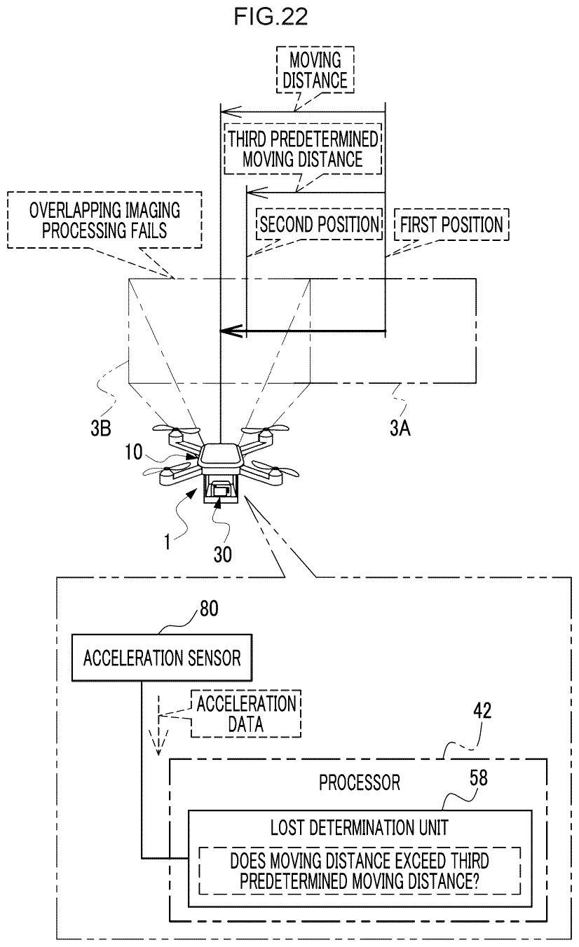

In the embodiment, the lost determination unit 58 determines whether or not the elapsed time that elapses from the first timing at which the first imaging target region 3A is imaged exceeds the first predetermined time (refer to FIG. 9). However, for example, as in the example illustrated in FIG. 22, the lost determination unit 58 may determine whether or not the moving distance by which the flying imaging apparatus 1 moves from the first position corresponding to the first timing exceeds a third predetermined moving distance.

The moving distance is derived based on the moving speed of the flying imaging apparatus 1 and on the elapsed time. For example, the moving speed of the flying imaging apparatus 1 is derived based on acceleration indicated by acceleration data input into the processor 42 from an acceleration sensor 80 mounted on the imaging apparatus 30 (that is, acceleration measured by the acceleration sensor 80). The acceleration sensor 80 is an example of an “acceleration sensor” according to the disclosed technology.

The third predetermined moving distance is the distance from the first position to the second position. As described above, the second position indicates the position of the center of the flying imaging apparatus 1 in a case where the overlapping amount by which a part of the first combination image 92A overlaps with a part of the overlapping determination image 94 reaches the lower limit value of the first predetermined range (refer to FIG. 7). In a case where a moving distance exceeds the third predetermined moving distance, an opportunity to image the second imaging target region 3B is lost. Thus, the imaging apparatus 30 fails to perform the overlapping imaging processing.

In a case where the moving distance is derived based on the acceleration measured by the acceleration sensor 80, whether or not the overlapping imaging processing fails is determined considering a change in the acceleration of the flying imaging apparatus 1. Accordingly, for example, determination accuracy can be improved compared to that in a case of determining whether or not the overlapping imaging processing fails without considering a change in the acceleration of the flying imaging apparatus 1.

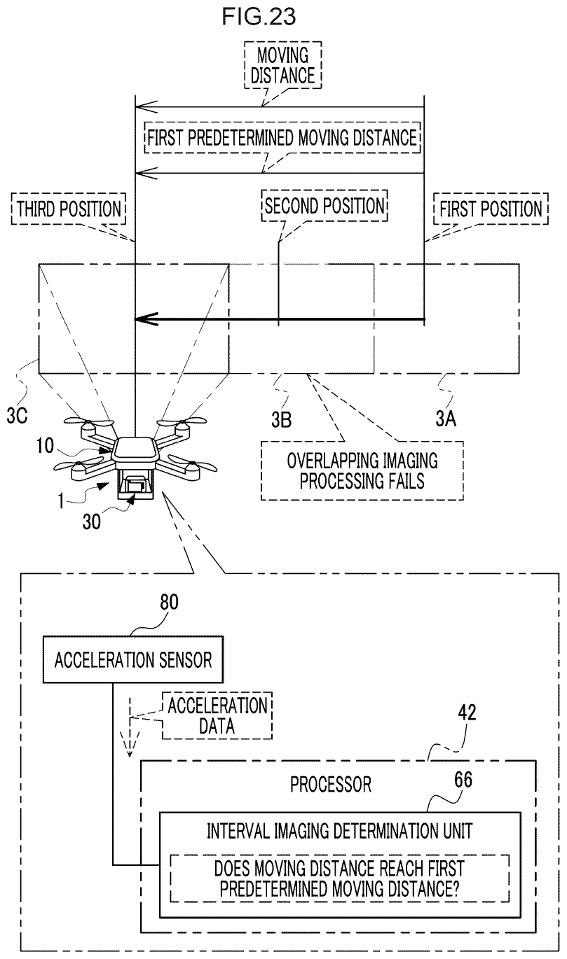

In the embodiment, the interval imaging determination unit 66 determines whether or not the elapsed time that elapses from the first timing at which the first imaging target region 3A is imaged reaches the second predetermined time (refer to FIG. 11). However, for example, as in the example illustrated in FIG. 23, the interval imaging determination unit 66 may determine whether or not the moving distance by which the flying imaging apparatus 1 moves from the first position corresponding to the first timing reaches the first predetermined moving distance.

The first predetermined moving distance is the distance from the first position to the third position. The third position indicates the position of the center of the flying imaging apparatus 1 in a case where it is assumed that the second combination image 92B is obtained by imaging the second imaging target region 3B and where the second overlapping amount by which a part of the third combination image 92C corresponding to the third imaging target region 3C overlaps with a part of the second combination image 92B reaches the upper limit value of the second predetermined range. In a case where the interval imaging determination unit 66 determines that the moving distance exceeds the first predetermined moving distance, the interval imaging processing is executed.

In a case where the moving distance is derived based on the acceleration measured by the acceleration sensor 80, whether or not to execute the interval imaging processing is determined considering a change in the acceleration of the flying imaging apparatus 1. Accordingly, for example, the determination accuracy can be improved compared to that in a case of determining whether or not to execute the interval imaging processing without considering a change in the acceleration of the flying imaging apparatus 1.

While the acceleration sensor 80 is mounted on the imaging apparatus 30 in the examples illustrated in FIGS. 22 and 23, the acceleration sensor 80 may be mounted on the flying object 10. The acceleration sensor 80 may also be mounted on each of the flying object 10 and the imaging apparatus 30, and the moving speed may be derived based on an average value of the acceleration measured by each acceleration sensor 80.

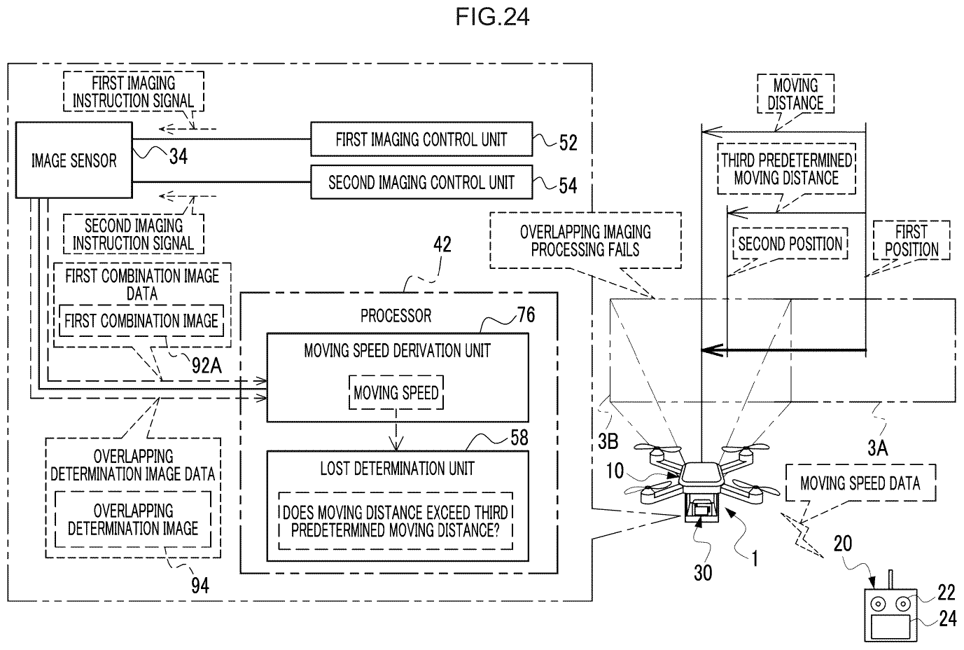

In the examples illustrated in FIGS. 22 and 23, the moving speed of the flying imaging apparatus 1 is derived based on the acceleration measured by the acceleration sensor 80. However, for example, as in the example illustrated in FIG. 24, the processor 42 may operate as a moving speed derivation unit 76, and the moving speed derivation unit 76 may derive the moving speed of the flying imaging apparatus 1 based on the first combination image 92A and on the overlapping determination image 94.

For example, the moving speed of the flying imaging apparatus 1 is derived in the following manner. That is, first, a moving distance (hereinafter, referred to as an “inter-image moving distance”) by which a feature point included in the first combination image 92A and the overlapping determination image 94 in common moves from a position included in the first combination image 92A to a position included in the overlapping determination image 94 is derived. The first combination image 92A and the overlapping determination image 94 are examples of a “sixth image” according to the disclosed technology.

Next, a moving distance (hereinafter, referred to as an “inter-region moving distance”) by which the second imaging target region 3B corresponding to the overlapping determination image 94 moves relative to the first imaging target region 3A corresponding to the first combination image 92A is derived based on a focal length in a case where the first combination image 92A and the overlapping determination image 94 are obtained and on the inter-image moving distance. A time interval (hereinafter, referred to as an “inter-image time interval”) in a case where the first combination image 92A and the overlapping determination image 94 are obtained is also derived. The moving speed of the flying imaging apparatus 1 is derived based on the inter-region moving distance and on the inter-image time interval.

As in the example illustrated in FIG. 24, the lost determination unit 58 may acquire the moving speed derived by the moving speed derivation unit 76 and derive the moving distance of the flying imaging apparatus 1 based on the moving speed and on the elapsed time. The lost determination unit 58 may determine whether or not the moving distance exceeds the third predetermined moving distance.

Even in a case where the moving speed of the flying imaging apparatus 1 is derived based on the first combination image 92A and on the overlapping determination image 94, whether or not the overlapping imaging processing fails is determined considering a change in the acceleration of the flying imaging apparatus 1. Accordingly, for example, the determination accuracy can be improved compared to that in a case of determining whether or not the overlapping imaging processing fails without considering a change in the acceleration of the flying imaging apparatus 1.

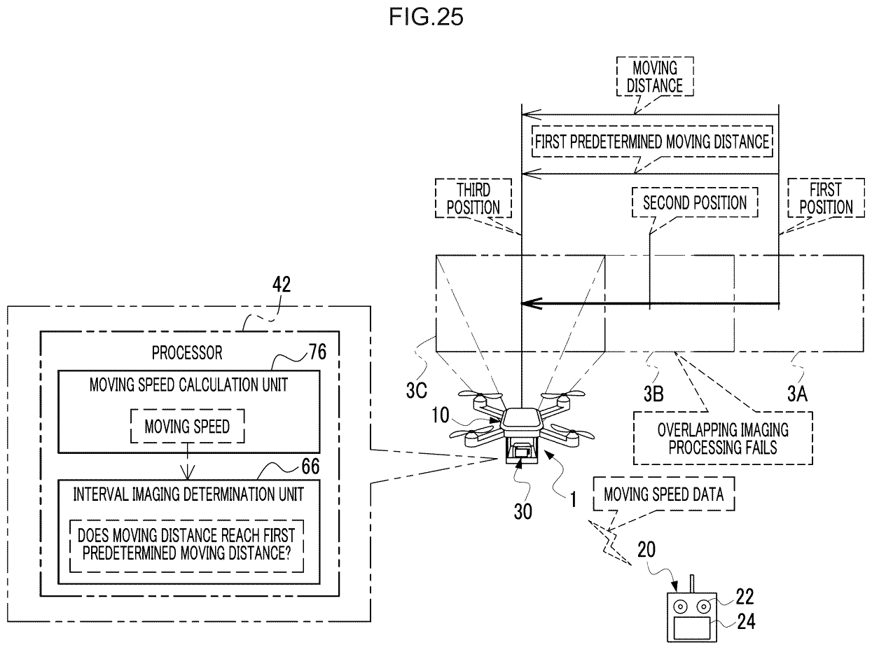

As in the example illustrated in FIG. 25, the interval imaging determination unit 66 may acquire the moving speed derived by the moving speed derivation unit 76 and derive the moving distance of the flying imaging apparatus 1 based on the moving speed and on the elapsed time. The interval imaging determination unit 66 may determine whether or not the moving distance reaches the first predetermined moving distance.

Even in a case where the moving speed of the flying imaging apparatus 1 is derived based on the first combination image 92A and on the overlapping determination image 94, whether or not to execute the interval imaging processing is determined considering a change in the acceleration of the flying imaging apparatus 1. Accordingly, for example, the determination accuracy can be improved compared to that in a case of determining whether or not to execute the interval imaging processing without considering a change in the acceleration of the flying imaging apparatus 1.

For example, as illustrated in FIGS. 24 and 25, the processor 42 may output moving speed data indicating the moving speed to the transmitter 20. The transmitter 20 may display the moving speed indicated by the moving speed data input from the imaging apparatus 30 on the display device 24.

In a case where the moving speed is displayed on the display device 24, the user can adjust the moving speed of the flying imaging apparatus 1 based on the moving speed displayed on the display device 24. The moving speed data is an example of “moving speed data” according to the disclosed technology. The first combination image 92A and the overlapping determination image 94 are examples of a “ninth image” according to the disclosed technology.

The embodiment is based on an assumption that an example (refer to FIG. 1) in which the flying imaging apparatus 1 images the plurality of imaging target regions 3 while moving in a zigzag manner by alternating moving in the horizontal direction and moving in the vertical direction. However, the flying imaging apparatus 1 may image the wall surface 2A while moving in any direction along the wall surface 2A of the target object 2.

While an example of mounting the imaging apparatus 30 on the flying object 10 is illustrated in the embodiment, the imaging apparatus 30 may be mounted on various moving objects (for example, a gondola, an automatic transport robot, an unmanned transport vehicle, or an aerial inspection vehicle) and the like.

While the combination image 92 is stored in the storage 44 in the embodiment, the combination image 92 may be stored in a storage medium other than the storage 44. While the lost information is stored in the storage 44 in the embodiment, the lost information may be stored in a storage medium other than the storage 44. The storage medium may be provided in an apparatus (for example, a server and/or a personal computer) other than the flying imaging apparatus 1. Examples of the storage medium include a computer-readable non-transitory storage medium such as a USB memory, an SSD, an HDD, an optical disc, and a magnetic tape.

While the processor 42 is illustrated in each embodiment, at least another CPU, at least one GPU, and/or at least one TPU may be used instead of the processor 42 or together with the processor 42.

While an example of an aspect of storing the imaging program 50 and the re-imaging program 100 in the storage 44 has been illustratively described in each embodiment, the disclosed technology is not limited to this. For example, the imaging program 50 and/or the re-imaging program 100 may be stored in a storage medium other than the storage 44. The imaging program 50 and/or the re-imaging program 100 stored in the storage medium may be installed on the computer 32 of the imaging apparatus 30.

The imaging program 50 and/or the re-imaging program 100 may be stored in a storage device of another computer, a server apparatus, or the like connected to the imaging apparatus 30 through a network, and the imaging program 50 and/or the re-imaging program 100 may be downloaded in accordance with a request of the imaging apparatus 30 and installed on the computer 32.

The storage device of another computer, a server apparatus, or the like connected to the imaging apparatus 30 or the storage 44 does not need to store the entire imaging program 50 and/or the re-imaging program 100 and may store a part of the imaging program 50 and/or the re-imaging program 100.

While the computer 32 is incorporated in the imaging apparatus 30, the disclosed technology is not limited to this. For example, the computer 32 may be provided outside the imaging apparatus 30.

While the computer 32 including the processor 42, the storage 44, and the RAM 46 is illustrated in each embodiment, the disclosed technology is not limited to this, and a device including an ASIC, an FPGA, and/or a PLD may be applied instead of the computer 32. A combination of a hardware configuration and a software configuration may also be used instead of the computer 32.

The following various processors can be used as a hardware resource for executing various types of processing described in each embodiment. Examples of the processors include a CPU that is a general-purpose processor functioning as the hardware resource for executing the various types of processing by executing software, that is, a program. Examples of the processors also include a dedicated electronic circuit such as an FPGA, a PLD, or an ASIC that is a processor having a circuit configuration dedicatedly designed to execute specific processing. Any of the processors incorporates or is connected to a memory, and any of the processors executes the various types of processing using the memory.

The hardware resource for executing the various types of processing may be composed of one of the various processors or may be composed of a combination of two or more processors of the same type or different types (for example, a combination of a plurality of FPGAs or a combination of a CPU and an FPGA). The hardware resource for executing the various types of processing may also be one processor.

Examples of the hardware resource composed of one processor include, first, an aspect of one processor composed of a combination of one or more CPUs and software, in which the processor functions as the hardware resource for executing the various types of processing. Second, as represented by an SoC or the like, an aspect of using a processor that implements functions of the entire system including a plurality of hardware resources for executing the various types of processing in one IC chip is included. Accordingly, the various types of processing are implemented using one or more of the various processors as the hardware resource.

More specifically, an electronic circuit in which circuit elements such as semiconductor elements are combined can be used as a hardware structure of the various processors. The various types of processing is merely an example. Accordingly, it is possible to delete unnecessary steps, add new steps, or rearrange a processing order without departing from the gist of the disclosed technology.

Above described content and illustrated content are detailed description for parts according to the disclosed technology and are merely an example of the disclosed technology. For example, description related to the above configurations, functions, actions, and effects is description related to examples of configurations, functions, actions, and effects of the parts according to the disclosed technology. Thus, it is possible to remove unnecessary parts, add new elements, or replace parts in the above described content and the illustrated content without departing from the gist of the disclosed technology. Particularly, description related to common technical knowledge or the like that is not required to be described for embodying the disclosed technology is omitted in the above described content and the illustrated content in order to avoid complication and facilitate understanding of the parts according to the disclosed technology.

In the present specification, “A and/or B” is synonymous with “at least one of A or B”. That is, “A and/or B” may mean only A, only B, or a combination of A and B. In the present specification, the same approach as “A and/or B” also applies to an expression of three or more matters connected with “and/or”.

All documents, patent applications, and technical standards disclosed in the present specification are incorporated in the present specification by reference to the same extent as those in a case where each of the documents, patent applications, and technical standards are specifically and individually indicated to be incorporated by reference.

What is claimed is:

1. An imaging control apparatus comprising:
a processor,
wherein the processor is configured to:
cause an imaging apparatus to image a first imaging target region;
in a case where a part of a second imaging target region overlaps with a part of the first imaging target region while a moving object on which the imaging apparatus is mounted is moving, perform overlapping imaging processing of causing the imaging apparatus to image the second imaging target region;
in a case where the overlapping imaging processing fails, perform interval imaging processing of causing the imaging apparatus to image a third imaging target region on a condition that a moving distance by which the moving object moves from a first position at which the first imaging target region is imaged by the imaging apparatus reaches a first predetermined moving distance;
in a case where the overlapping imaging processing fails, acquire positional information related to a position of the second imaging target region, first image information related to a seventh image obtained by imaging the first imaging target region via the imaging apparatus, and second image information related to an eighth image obtained by imaging the third imaging target region via the imaging apparatus, and
the positional information related to the position of the second imaging target region is stored in a memory in association with image information of at least one of the first image information or the second image information.

2. The imaging control apparatus according to claim 1,
wherein a case where the overlapping imaging processing fails includes a case where the second imaging target region is not imaged by the imaging apparatus and where the moving distance exceeds a distance from the first position to a second position at which the second imaging target region is to be imaged by the imaging apparatus.

3. The imaging control apparatus according to claim 1,
wherein a case where the overlapping imaging processing fails includes a case where the second imaging target region is imaged by the imaging apparatus and where a first overlapping amount by which a part of a first image obtained by imaging the first imaging target region overlaps with a part of a second image obtained by imaging the second imaging target region falls outside a first predetermined range.

4. The imaging control apparatus according to claim 1,
wherein a case where the overlapping imaging processing fails includes a case where a third image obtained by imaging the second imaging target region via the imaging apparatus does not satisfy predetermined image quality.

5. The imaging control apparatus according to claim 1,
wherein a part of the third imaging target region overlaps with a part of the second imaging target region.

6. The imaging control apparatus according to claim 1,
wherein the first predetermined moving distance is a distance from the first position to a third position at which a part of the third imaging target region overlaps with a part of the second imaging target region.

7. The imaging control apparatus according to claim 1,
wherein the first predetermined moving distance is a distance that is longer by a factor of a natural number greater than or equal to 2 than a distance from the first position to a fourth position at which the second imaging target region is to be imaged by the imaging apparatus.

8. The imaging control apparatus according to claim 1,
wherein the overlapping imaging processing is performed on a condition that a second overlapping amount by which a part of a fourth image obtained by imaging the first imaging target region via the imaging apparatus overlaps with a part of a fifth image obtained by imaging the second imaging target region via the imaging apparatus falls within a second predetermined range.

9. The imaging control apparatus according to claim 1,
wherein the moving distance is derived based on acceleration measured by an acceleration sensor mounted on the imaging apparatus and/or the moving object.

10. The imaging control apparatus according to claim 1,
wherein a determination that the moving distance reaches the first predetermined moving distance is made on a condition that in a case where the moving object moves at a constant speed, a time that elapses from a first timing at which the first imaging target region is imaged by the imaging apparatus reaches a first predetermined time.

11. The imaging control apparatus according to claim 1,
wherein the moving distance is derived based on a moving speed of the moving object derived based on a plurality of sixth images obtained by imaging performed by the imaging apparatus and on a time interval in a case where the plurality of sixth images are obtained.

12. The imaging control apparatus according to claim 1,
wherein the processor is configured to:
acquire a moving speed of the moving object; and
output moving speed data indicating the moving speed, and
the moving speed is derived based on a plurality of ninth images obtained by imaging performed by the imaging apparatus.

13. An imaging control method comprising:
causing an imaging apparatus to image a first imaging target region;
performing, in a case where a part of a second imaging target region overlaps with a part of the first imaging target region while a moving object on which the imaging apparatus is mounted is moving, overlapping imaging processing of causing the imaging apparatus to image the second imaging target region;
performing, in a case where the overlapping imaging processing fails, interval imaging processing of causing the imaging apparatus to image a third imaging target region on a condition that a moving distance by which the moving object moves from a first position at which the first imaging target region is imaged by the imaging apparatus reaches a first predetermined moving distance;
performing, in a case where the overlapping imaging processing fails, acquire positional information related to a position of the second imaging target region, first image information related to a seventh image obtained by imaging the first imaging target region via the imaging apparatus, and second image information related to an eighth image obtained by imaging the third imaging target region via the imaging apparatus, and
the positional information related to the position of the second imaging target region is stored in a memory in association with image information of at least one of the first image information or the second image information.

14. A non-transitory computer-readable storage medium storing a program causing a computer to execute a process comprising:
causing an imaging apparatus to image a first imaging target region;
performing, in a case where a part of a second imaging target region overlaps with a part of the first imaging target region while a moving object on which the imaging apparatus is mounted is moving, overlapping imaging processing of causing the imaging apparatus to image the second imaging target region;
performing, in a case where the overlapping imaging processing fails, interval imaging processing of causing the imaging apparatus to image a third imaging target region on a condition that a moving distance by which the moving object moves from a first position at which the first imaging target region is imaged by the imaging apparatus reaches a first predetermined moving distance;
performing, in a case where the overlapping imaging processing fails, acquire positional information related to a position of the second imaging target region, first image information related to a seventh image obtained by imaging the first imaging target region via the imaging apparatus, and second image information related to an eighth image obtained by imaging the third imaging target region via the imaging apparatus, and
the positional information related to the position of the second imaging target region is stored in a memory in association with image information of at least one of the first image information or the second image information.
